(19) United States
(12) Patent Application Publication
(10) Pub. No.: US 2014/0359663 A1
(43) Pub. Date: Dec. 4, 2014

(54) INFORMATION PROCESSOR AND DISPLAY CONTROL METHOD

(71) Applicant: Kabushiki Kaisha Toshiba, Tokyo (JP)

(72) Inventor: Akira NAKANISHI, Tokyo (JP)

(73) Assignee: Kabushiki Kaisha Toshiba, Tokyo (JP)

(21) Appl. No.: 14/137,058

(22) Filed: Dec. 20, 2013

(30) Foreign Application Priority Data
May 31, 2013 (JP) 2013-116184

(51) Int. Cl. H04N 21/485

(52) U.S. Cl. CPC H04N 21/4858
USPC 725/37

(57) ABSTRACT

According to one embodiment, an information processor includes a display, an operating module, and a controller. The display includes a display screen. The operating module is configured to be capable of receiving an operation with respect to an image displayed on the display screen. The controller is configured to receive, from an external display device, layout information on layout of a plurality of display images displayed on an external display screen of the external display device, and to bring, based on the received layout information, a layout of a plurality of operation images displayable on the display screen and corresponding to the respective display images close to the layout of the display images corresponding to the operation images.

### CROSS-REFERENCE TO RELATED APPLICATIONS

This application is based upon and claims the benefit of priority from Japanese Patent Application No. 2013-116184, filed May 31, 2013, the entire contents of which are incorporated herein by reference.

### FIELD

Embodiments described herein relate generally to an information processor and a display control method.

### BACKGROUND

As televisions (an example of an external display device) become highly functionalized and multi-functionalized, a novel television is disclosed that implements external expansion modularization that installs a partial function of a television in an external device and provides an expansion slot to which the external device can be connected, thereby supporting customization and upgrading.

It is common that a television is provided with an application that allows portable terminal devices (an example of an information processor) such as a smartphone and a tablet to remotely operate a window (an example of a display image) displayed through a function of the television (hereinafter called a remote controlling application). However, the conventional remote controlling application is aimed at allowing a portable terminal device to operate a window displayed through a single function of a television, and fails to allow a portable terminal device to simultaneously operate a plurality of windows displayed by a plurality of functions of an externally modularized television.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a configuration of a display control system according to a first embodiment;

FIG. 2 is an exemplary diagram for explaining an expansion slot of a display device in the first embodiment;

FIG. 3 is an exemplary diagram for explaining generation of an IP address in an expansion card connected to the display device in the first embodiment;

FIG. 4 is an exemplary block diagram of a configuration of an information processor in the first embodiment;

FIG. 5 is an exemplary block diagram of a functional configuration of the display device and the information processor in the first embodiment;

FIG. 6 is an exemplary sequence diagram of processing that implements the GUI of an expansion card in the information processor in the display control system in the first embodiment;

FIGS. 7A and 7B are exemplary diagrams of one example of an expansion card list transmitted from the display device in the first embodiment;

FIG. 8 is an exemplary diagram of one example of GUI information transmitted from the display device in the first embodiment;

FIG. 9 is an exemplary diagram of one example of an operating panel displayed on the information processor in the first embodiment;

FIG. 10 is an exemplary diagram for explaining processing that displays an operating panel on the information processor in the first embodiment;

FIG. 11 is an exemplary diagram of one example of an event transmitted through an operation on the operating panel displayed on the information processor in the first embodiment;

FIG. 12 is an exemplary sequence diagram of processing that allows the information processor to implement the GUI of a new expansion card in the display control system in the first embodiment;

FIGS. 13A and 13B are exemplary diagrams for explaining processing that implements GUIs of a plurality of expansion cards in the information processor of the display control system in the first embodiment;

FIGS. 14A and 14B are exemplary diagrams for explaining a layout of an operating panel displayed on a display screen of the information processor in the first embodiment;

FIGS. 15A and 15B are exemplary diagrams for explaining processing that changes the layout of an operating panel displayable on the display screen of the information processor in the display control system in the first embodiment;

FIGS. 16A and 16B are exemplary diagrams for explaining processing that change the layout of a plurality of windows displayed on a display screen of the display device in the display control system in the first embodiment;

FIGS. 17A to 17D are exemplary diagrams for explaining processing that changes the layout of operating panels in the information processor in the first embodiment;

FIGS. 18A to 18C are exemplary diagrams for explaining processing that switches an operating panel displayed on a display screen of an information processor according to a first modification;

FIGS. 19A to 19E are exemplary diagrams for explaining processing that changes the layout direction of a plurality of operating panels in an information processor according to a second modification;

FIGS. 20A to 20C are exemplary diagrams of a display example of position information on a display screen of an information processor according to a third modification;

FIGS. 21A to 21C are exemplary diagrams of another display example of position information on the display screen of the information processor in the third modification;

FIGS. 22A to 22C are exemplary diagrams for explaining processing that switches an operating panel displayed on a display screen of an information processor according to a fourth modification;

FIGS. 23A to 23C are exemplary diagrams for explaining processing that switches an operating panel displayed on the display screen of the information processor in the fourth modification;

FIGS. 24A to 24E are exemplary diagrams for explaining processing that displays a window corresponding to an operating panel other than an image to be displayed whose display is ended in a full-screen manner in a display device according to a second embodiment; and

FIGS. 25A to 25D are exemplary diagrams for explaining processing that displays a window corresponding to an operating panel other than an image to be displayed whose display is ended in a full-screen manner in the display device in the second embodiment.

### DETAILED DESCRIPTION

In general, according to one embodiment, an information processor comprises a display, an operating module, and a controller. The display comprises a display screen. The operating module is configured to be capable of receiving an operation with respect to an image displayed on the display screen. The controller is configured to receive, from an external display device, layout information on layout of a plurality of display images displayed on an external display screen of the external display device, and to bring, based on the received layout information, a layout of a plurality of operation images displayable on the display screen and corresponding to the respective display images close to the layout of the display images corresponding to the operation images.

The following describes an information processor and a display control method according to embodiments with reference to the attached drawings.

### First Embodiment

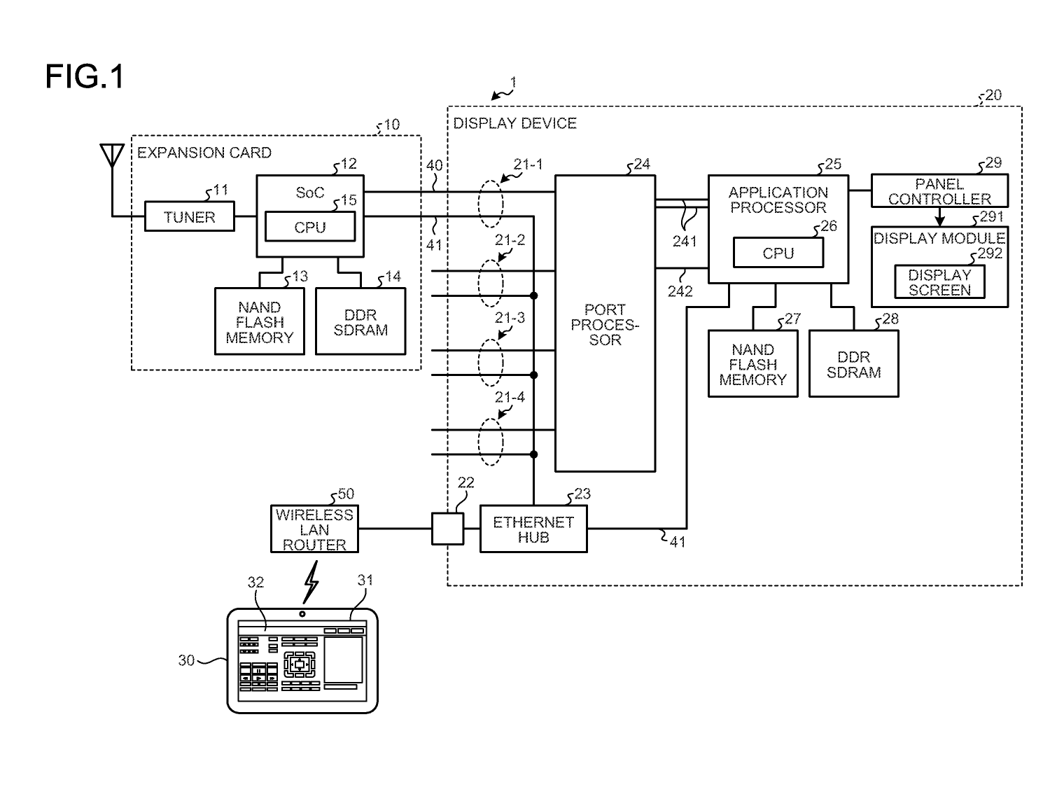

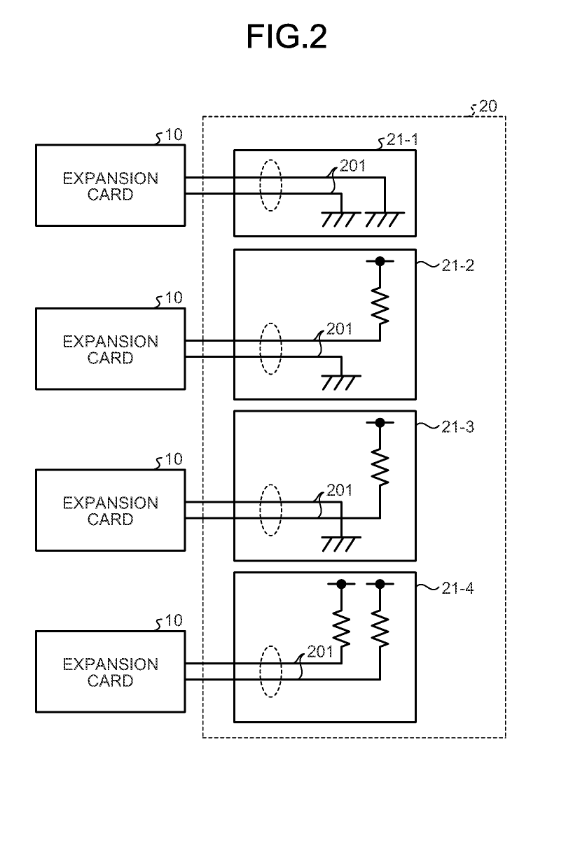

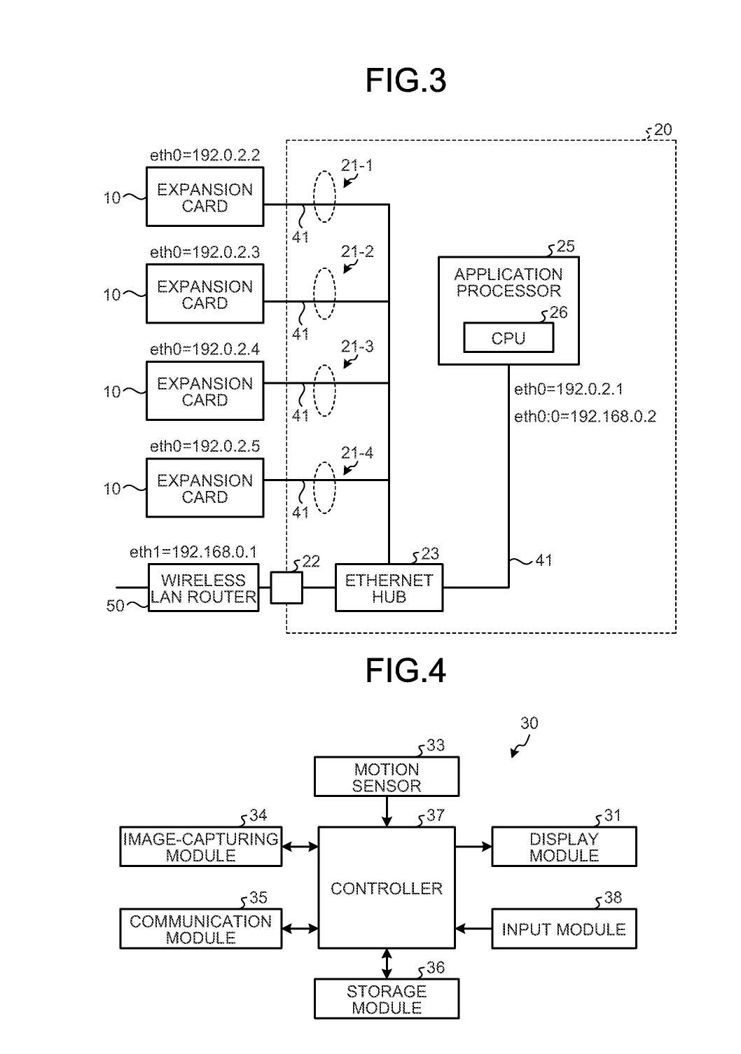

There is described a configuration of a display control system according to a first embodiment, with reference to FIGS. 1 to 4. FIG. 1 is a block diagram illustrating the configuration of the display control system according to the first embodiment. FIG. 2 is a diagram for explaining an expansion slot of a display device in the first embodiment. FIG. 3 is a diagram for explaining the generation of an IP address in an expansion card connected to the display device in the first embodiment. FIG. 4 is a block diagram illustrating the configuration of an information processor in the first embodiment.

This display control system 1 according to the present embodiment comprises a display device 20 (for example, a television) capable of displaying a plurality of windows such as windows displayed with an expanded function through the connection of an expansion card 10 on one screen and an information processor 30 (for example, a tablet terminal or a smartphone) through which an operation on the display device 20 is input.

The expansion card 10 is an example of an external device that can expand the function of the display device 20. For example, the expansion card 10 has a function of receiving a specific type of broadcasting (for example, terrestrial television broadcasting, BS television broadcasting, CS television broadcasting, and cable television). The present embodiment describes a case in which the expansion card 10 having a function of receiving a specific type of broadcasting is connected to the display device 20. However, the present embodiment is not limited thereto. Examples of the external device connectable to the display device 20 include an image processor having a function of performing image processing on an image displayed on a display module of the display device 20 and a recorder that stores therein broadcast data such as broadcast video of broadcasting received by the display device 20.

As illustrated in FIG. 1, the expansion card 10 having a function of receiving a specific type of broadcasting comprises: a tuner 11 that receives a specific type of broadcasting; a system on chip (SoC) 12 having a central processing unit (CPU) 15 that performs selection of broadcasting to be received by the tuner 11 and decoding of the broadcasting received by the tuner 11; a NAND flash memory 13 that stores therein various kinds of information such as an expansion card ID that identifies the expansion card 10, a control program of the expansion card 10, an operating system (OS), and GUI information for use in the implementation of a graphical user interface (GUI) of the expansion card 10 (for example, the layout of graphics as operation images such as windows, icons, and buttons displayed through the implementation of the GUI of the expansion card 10 on the information processor 30, the type of buttons displayed through the implementation of the GUI of the expansion card 10 on the information processor 30, and the codes of the buttons); and a double data rate synchronous dynamic random access memory (DDR SDRAM) 14 used as a working memory of the CPU 15.

Described next is the configuration of the display device 20 according to the present embodiment. The display device 20 comprises expansion slots 21-1, 21-2, 21-3, and 21-4, an Ethernet (registered trademark) terminal 22, an Ethernet hub 23, a port processor 24, an application processor 25, a NAND flash memory 27, a DDR SDRAM 28, a panel controller 29, and a display module 291.

An external device such as the expansion card 10 is connectable to the expansion slots (expansion buses) 21-1, 21-2, 21-3, and 21-4. As a result, the display device 20 is sold in a store while mounted with a module (the expansion card 10) having a function of receiving, for example, terrestrial digital broadcasting. Having purchased the display device 20 in the store, a customer purchases the expansion card 10 having a function of receiving a specific type of broadcasting and connects it to any one of the expansion slots 21-1, 21-2, 21-3, and 21-4 to increase the types of broadcasting receivable by the display device 20. In the manufacturing stage of the display device 20, a function to be installed in the display device 20 can be changed in accordance with sales area, grade, or the like of the display device 20 by changing the expansion card 10 to be connected to the expansion slot 21-1, 21-2, 21-3, or 21-4. This eliminates the need to manufacture specialized boards or the like for each sales area or grade of the display device 20. In the following description, when the expansion slots 21-1, 21-2, 21-3, and 21-4 are not required to be distinguished from each other, they are denoted simply as an expansion slot 21. In the present embodiment, the display device 20 has four expansion slots 21-1, 21-2, 21-3, and 21-4. However, without being limited thereto, the display device 20 only needs to have at least one expansion slot 21.

The expansion slot 21 in the present embodiment transmits and receives various kinds of information to and from the expansion card 10 that is connected through an HDMI I/F 40 compliant with the HDMI (registered trademark: High Definition Multimedia Interface) standard and the Ethernet 41.

In the present embodiment, as illustrated in FIG. 2, the expansion slot 21 comprises a signal line 201 that allows the expansion card 10 to acquire slot information (information indicating the expansion slot 21 to which the expansion card 10 is connected, such as a slot number). The CPU 15 of the expansion card 10 acquires a slot number in accordance with a signal input from the signal line 201 of the expansion slot 21. The CPU 15 then generates an IP address of the expansion card 10 (hereinafter called the internal IP address) using the acquired slot number and communicates with the display device 20 using the generated internal IP address.

For example, when the expansion card 10 is connected to the expansion slot 21-1, the CPU 15 of the expansion card 10 acquires a value obtained by adding “1” to a signal “00” input from the signal line 201, as a slot number of “1.” As illustrated in FIG. 3, the CPU 15 of the expansion card 10 then generates a value “192.0.2.2” obtained by adding the acquired slot number “1” to the fourth value “1” (a value of the least significant byte, or a host address) of the internal IP address “192.0.2.1” of the application processor 25, as the internal IP address eth0 of the expansion card 10. As illustrated in FIG. 3, when the expansion card 10 is connected to the expansion slot 21-2, 21-3, or 21-4, the CPU 15 of the expansion card 10 similarly acquires a slot number and generates an internal IP address eth0 using the acquired slot number.

The Ethernet terminal 22 is connected to a wireless local area network (LAN) router 50 and performs communications with the information processor 30 by wireless LAN through the wireless LAN router 50.

The Ethernet hub 23 relays communications among the expansion card 10 connected to the expansion slot 21, the application processor 25, and the information processor 30.

The port processor 24 selects an expansion slot 21 to which an expansion card 10 having a function of receiving broadcasting to be displayed among a plurality of expansion slots 21 (expansion slots 21 to which expansion cards 10 each having a function of receiving a specific type of broadcasting are connected). In the present embodiment, the port processor 24 selects two or more expansion slots 21 among a plurality of expansion slots 21. The port processor 24 then acquires from the expansion card 10 connected to the selected expansion slot 21 the broadcast data of broadcasting received by the expansion card 10. The port processor 24 then outputs the acquired broadcast data to the application processor 25 through an HDMI I/F 241.

The NAND flash memory 27 stores therein a main control program or the like that controls the display device 20. The DDR SDRAM 28 is used as a working memory of a CPU 26 of the application processor 25.

The application processor 25 controls the entire display device 20. In the present embodiment, the application processor 25 has the CPU 26 that executes the main system control program stored in the NAND flash memory 27.

The application processor 25 is connected to the port processor 24 through an I2C bus 242 other than the HDMI I/F 241, and the CPU 26 controls the port processor 24 through the I2C bus 242. In the present embodiment, the CPU 26 detects, through the port processor 24, new connection of the expansion card 10 to the expansion slot 21 periodically (for example, once a second).

The CPU 26 then, from its own internal IP address (of the application processor 25) set in advance and the slot number of the detected expansion card 10, generates an internal IP address of the detected expansion card 10 (the method for generating the internal IP address of the expansion card 10 is the same as the above-described method for generating the internal IP address with the CPU 15 of the expansion card 10). The CPU 26 then, with the generated internal IP address, controls the detected expansion card 10 using the hypertext transfer protocol (HTTP) through the Ethernet 41. The CPU 26 uses the HTTP to instruct, through the Ethernet 41, the control program of the detected expansion card 10 to transmit various kinds of information of the expansion card 10 (for example, GUI information for use in the implementation of the GUI of the expansion card 10) and acquires the various kinds of information of the detected expansion card 10 from the detected expansion card 10.

The CPU 26 controls the outputting of broadcast data to the application processor 25 by the port processor 24 (in other words, the above-described selection of the expansion slot 21 by the port processor 24) through the I2C bus 242.

The CPU 26 receives, through the HDMI I/F 241, the broadcast data output from the port processor 24 and outputs the received broadcast data to the panel controller 29, thereby causing a display screen 292 (for example, a liquid crystal display (LCD)) of the display module 291 to display a window of broadcast video (an example of a display image) included in the received broadcast data. When the port processor 24 acquires the broadcast data of broadcasting received by two or more expansion cards 10, the CPU 26 may receive two or more pieces of broadcast data output from the port processor 24 and cause one screen (the display screen 292) to display a plurality of windows of broadcast video included in the respective two or more pieces of broadcast data.

The present embodiment describes an example in which the display screen 292 displays a window of broadcast video included in broadcast data received from the port processor 24. However, without being limited to the above example, the display screen 292 may also display a plurality of windows (an example of a display image) including a window of broadcast video included in the broadcast data of broadcasting received by a tuner of the display device 20 and a window of a web page published on a network.

The CPU 26 communicates with the outside wireless LAN router 50 through the Ethernet 41 to connect to a network such as the Internet. This allows the CPU 26 to perform communications with the information processor 30 through which an operation on the display device 20 is input and acquire web pages or the like published on the network.

In the present embodiment, as illustrated in FIG. 3, the CPU 26 sets an external IP address (in the present embodiment, eth0:0=“192.168.0.2”) to the same network adapter (not illustrated) as for interior communication use using an IP alias. The external IP address is externally acquired, for example, by being set in advance by a user or acquired from the wireless LAN router 50 using the dynamic host configuration protocol (DHCP). The CPU 26 then communicates with the wireless LAN router 50 with an IP address eth1=“192.168.0.1” through the external IP address. In the present embodiment, the CPU 26 communicates with the information processor 30 through the Ethernet 41. However, without being limited to the Ethernet, the CPU 26 may communicate with the information processor 30 through, for example, Bluetooth (registered trademark).

Described next is the configuration of the information processor 30 according to the present embodiment. As illustrated in FIG. 1 and FIG. 4, the information processor 30 according to the present embodiment comprises a display module 31, an input module 38, a motion sensor 33, an image-capturing module 34, a communication module 35, a storage module 36, and a controller 37. Although not illustrated, the information processor 30 also comprises a speaker and a microphone.

The display module 31 can display various kinds of information (for example, graphics through the implementation of the GUI of the expansion card 10) under the control of the controller 37. Specifically, the display module 31 has a display screen 32 configured with an LCD, an organic electroluminescence (EL) display, or the like and can display the various kinds of information on the display screen 32.

The input module 38, which is configured with, for example, a pointing device or a button, is an operating module through which an operation (for example, various instructions and various kinds of information input by a user) is input on an image displayed on the display screen 32 of the display module 31. In the present embodiment, the input module 38 comprises, as a pointing device, a touch panel having a transparent coordinates detector placed on the display screen 32 of the display module 31. However, the input module 38 is not limited thereto.

The motion sensor 33 comprises an acceleration sensor, an angular acceleration sensor, and a tilt sensor to detect a change in the attitude or position (motion, tilt, rotation, or the like) of the information processor 30.

The image-capturing module 34 captures an image of a subject.

The communication module 35 is a communication interface connectable to a network such as the Internet. The communication module 35 communicates with an external device (for example, the display device 20) connected to the network under the control of the controller 37.

The storage module 36 has a nonvolatile storage medium such as a read only memory (ROM), a hard disk drive (HDD), and a solid state drive (SSD) and stores therein various computer programs or the like such as an application (hereinafter called the remote controlling application) and the like through which the information processor 30 operates the display device 20. The remote controlling application is downloaded from a server on a network such as the Internet and stored in the storage module 36.

The controller 37 has a CPU, a ROM, a random access memory (RAM), and the like (all of which are not illustrated) and cooperates with the programs stored in the storage module 36, thereby comprehensively controlling the operation of the information processor 30.

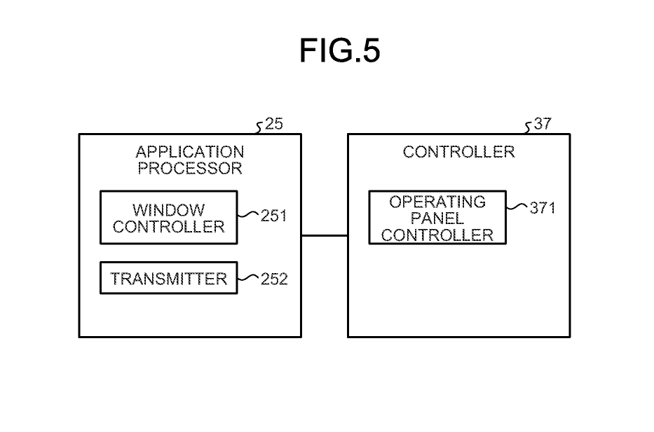

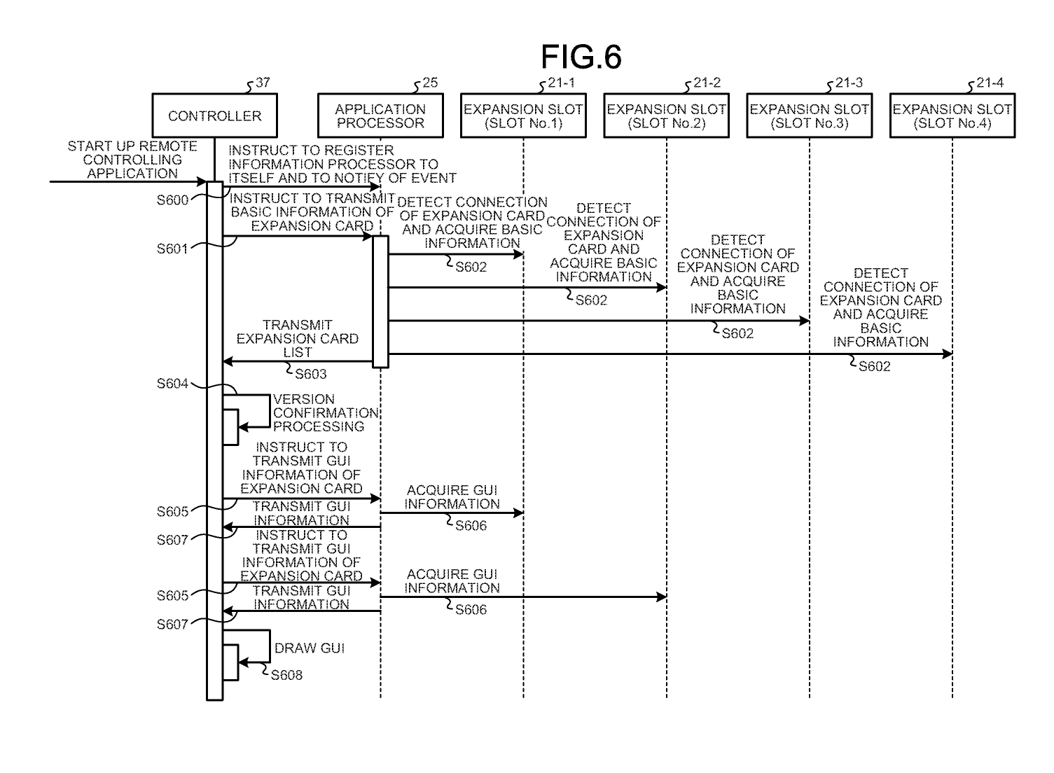

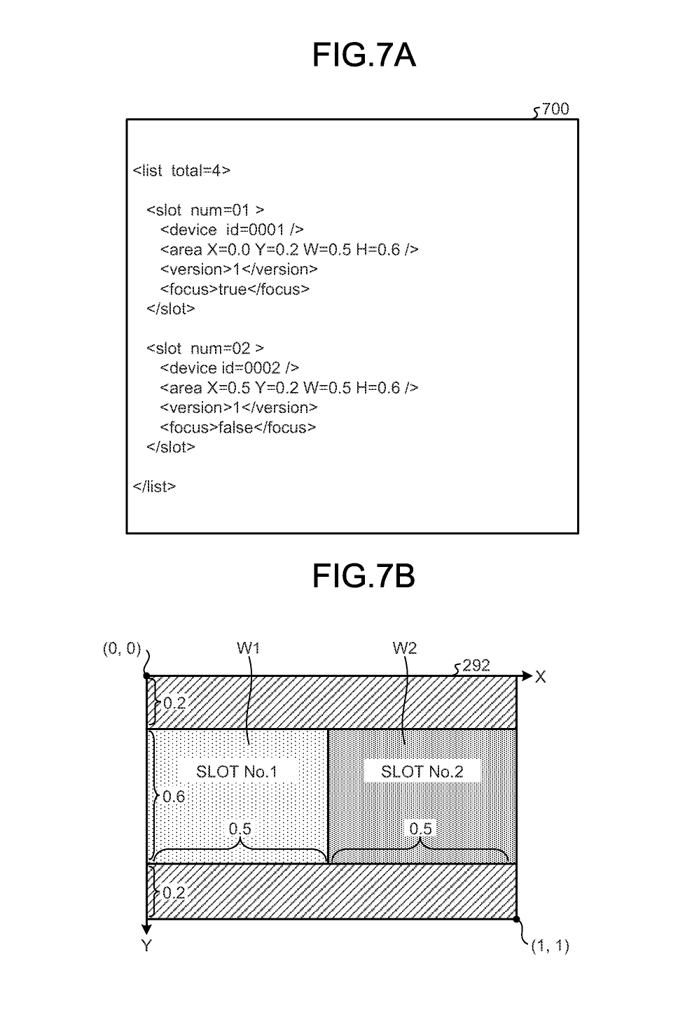

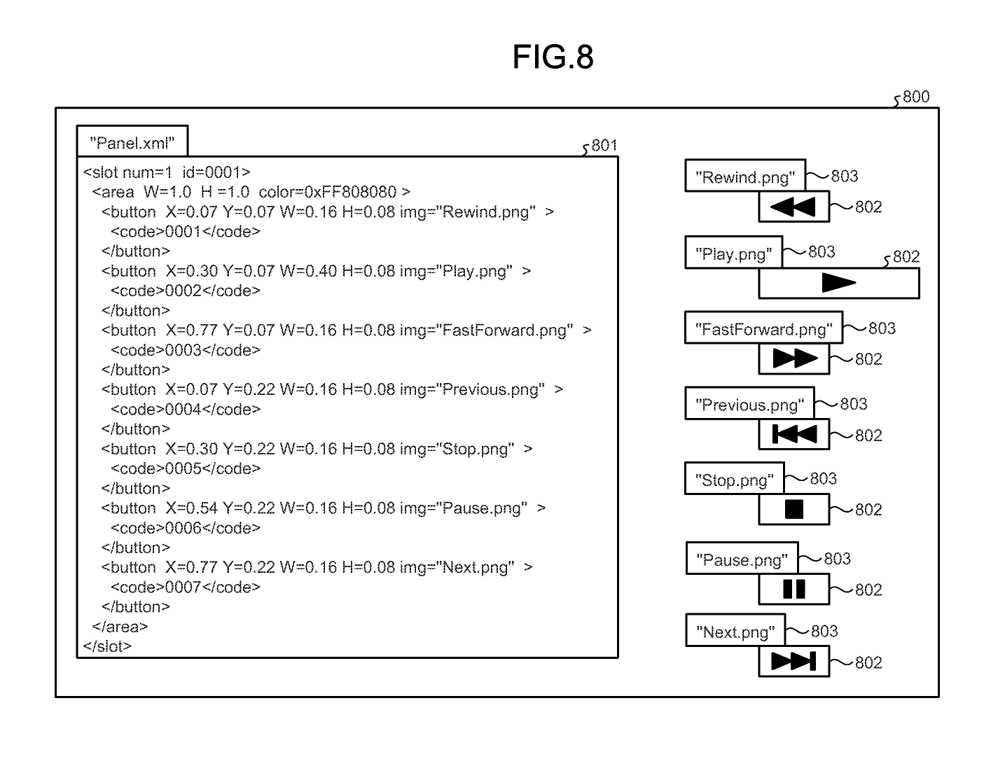

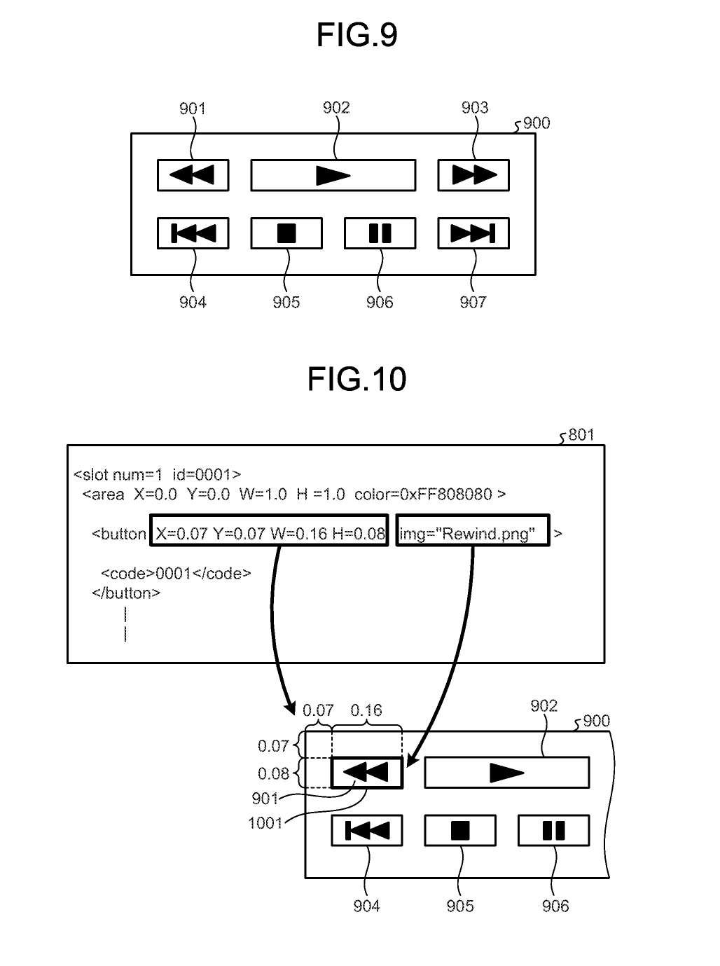

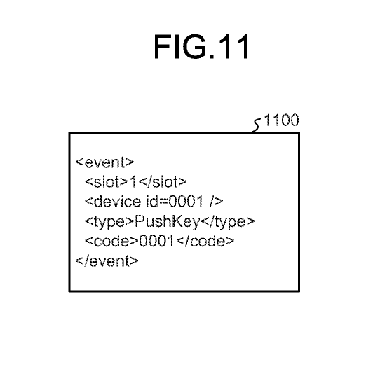

Described next with reference to FIGS. 5 to 11 is processing that implements the GUI of the expansion card 10 in the information processor 30. FIG. 5 is a block diagram illustrating the functional configuration of the display device and the information processor in the first embodiment. FIG. 6 is a sequence diagram illustrating the flow of processing that implements the GUI of the expansion card in the information processor in the display control system in the first embodiment. FIG. 7 is a diagram illustrating one example of an expansion card list transmitted from the display device in the first embodiment. FIG. 8 is a diagram illustrating one example of GUI information transmitted from the display device in the first embodiment. FIG. 9 is a diagram illustrating an example of an operating panel displayed on the information processor in the first embodiment. FIG. 10 is a diagram for explaining processing that displays the operating panel on the information processor in the first embodiment. FIG. 11 is a diagram illustrating one example of an event transmitted through an operation on the operating panel displayed on the information processor in the first embodiment.

In the display device 20, the CPU 26 of the application processor 25 executes the main control program stored in the NAND flash memory 27, thereby as illustrated in FIG. 5, implementing a window controller 251 and a transmitter 252. The window controller 251 causes the display screen 292 to display a plurality of windows such as broadcast video included in the broadcast data of broadcasting received by the expansion card 10 connected to the expansion slot 21. The transmitter 252 transmits (inputs) layout information (arrangement information) on the layout (arrangement) of the windows displayed on the display screen 292 to the information processor 30.

In the present embodiment, described is an example in which the transmitter 252 transmits GUI information for use in the implementation of the GUI of the external device. However, when the window displayed on the display screen 292 is a window displayed by a function of the display device 20, GUI information for use in the implementation of the GUI of the function of the display device 20 is transmitted to the information processor 30.

In the information processor 30, a CPU or the like of the controller 37 executes the remote controlling application stored in the storage module 36, thereby as illustrated in FIG. 5, receiving the layout information from the display device 20 (an example of an external display device). Based on the input layout information, an operating panel controller 371 (an example of a display controller) is implemented that brings the layout of a plurality of operation images displayable on the display screen 32 of the information processor 30 and corresponding to the respective windows displayed on the display screen 292 of the display device 20 (in the present embodiment, graphics through the implementation of the GUI of the expansion card 10 connected to the display device 20 (hereinafter called the operating panel)) close to the layout of the windows corresponding to the operation images.

In the present embodiment, as an example of the information processor 30 capable of displaying the operation images corresponding to the respective windows displayed on the display screen 292 of the display device 20, a portable terminal device such as a smartphone or a tablet terminal is adopted. However, without being limited thereto, for example, a stationary device such as a notebook PC may be adopted as the information processor 30 capable of displaying the operation images corresponding to the respective windows displayed on the display screen 292 of the display device 20.

When the remote controlling application starts up, the controller 37 of the information processor 30 instructs the display device 20 to register the device (the information processor 30) and to inform the information processor 30 of various events (for example, detection of the connection of the expansion card 10) (S600). The controller 37 then instructs the display device 20 to transmit the basic information of the expansion card 10 connected to the expansion slot 21 of the display device 20 (S601).

When instructed to register the information processor 30 and inform the information processor 30 of various events, the application processor 25 of the display device 20 stores the IP address of the information processor 30 in the DDR SDRAM 28, thereby registering the information processor 30. The application processor 25 then starts to inform the information processor 30 of various events in the display device 20 using the IP address stored in the DDR SDRAM 28.

When instructed to send the basic information of the expansion card 10 connected to the expansion slot 21, the window controller 251 detects, through the port processor 24, the connection of the expansion card 10 to any of the expansion slots 21-1, 21-2, 21-3, and 21-4 (S602). The window controller 251 then acquires the basic information of the expansion card 10 whose connection to the expansion slot 21 was detected (S602). The basic information here is information related to the expansion card 10 including the slot number of the expansion slot 21 to which the expansion card 10 is connected, an ID indicating the model number of the expansion card 10, and the version of the remote controlling application required for the control of the expansion card 10.

In the present embodiment, the window controller 251 detects, through the port processor 24, the connection of the expansion card 10 to any of the expansion slots 21-1, 21-2, 21-3, and 21-4 periodically (for example, once a second). When new connection of the expansion cards 10 to the expansion slots 21 (for example, the expansion slots 21-1 and 21-2) is detected, the window controller 251 acquires the basic information of the expansion cards 10 from the expansion cards 10 connected to the expansion slots 21-1 and 21-2.

In the present embodiment, the window controller 251 detects the connection of the expansion card 10 to the expansion slot 21. However, the window controller 251 is not limited thereto, so long as it detects the connection of an external device capable of expanding the function of the display device 20. For example, the window controller 251 may detect the connection of an external device through a network such as the Internet.

The transmitter 252 transmits an expansion card list including the acquired basic information of the expansion card 10 to the information processor 30 (S603). In the present embodiment, as illustrated in FIG. 7A, the transmitter 252 transmits an expansion card list converted into the extensible markup language (XML) format to the information processor 30. Specifically, the attribute of the <list> tag included in this expansion card list 700 indicates the number of the expansion slots 21 of the display device 20 (“total=4”). The expansion card list 700 includes as many <slot> tags as the numbers of the expansion slots 21-1 and 21-2 whose connection of the expansion cards 10 was detected.

The attribute of the <slot> tag indicates the slot number of the expansion slot 21 whose connection of the expansion card 10 was detected (for example, “num=01” and “num=02”). The attribute of the <device> tag in the <slot> tag indicates an ID indicating the model number of the expansion card 10 connected to the expansion slot 21 (for example, “id=0001” and “id=0002”).

When the expansion card 10 whose connection to the expansion slot 21 was detected has a function of receiving a specific type of broadcasting and the display screen 292 displays a window of broadcast video included in broadcast data received by the expansion card 10, the attribute of the <area> tag in the <slot> tag indicates layout information on the layout of the window on the display screen 292 (in the present embodiment, the coordinates and size of the window of the broadcast video). The transmitter 252 thus inputs the layout information of a plurality of windows displayed on the display screen 292 of the display device 20 to the information processor 30.

For example, when two expansion cards 10 having a function of receiving a specific type of broadcasting are connected to the expansion slots 21-1 and 21-2, as illustrated in FIG. 7B, the window controller 251 arranges, on the display screen 292, windows W1 and W2 on which broadcast video included in broadcast data received by the two expansion cards 10 are displayed. In this case, the attribute of the <area> tag in the <slot num=01> tag indicates the coordinates of the window W1 (in the present embodiment, the upper-left coordinates of the window W1 (X=0.0, Y=0.2)) on the display screen 292 and the size of the window W1 (in the present embodiment, the width of the window W1 (W=0.5) and the height of the window W1 (H=0.6)) on the display screen 292.

The attribute of the <area> tag in the <slot num=02> tag indicates the coordinates of the window W2 (in the present embodiment, the upper-left coordinates of the window W2 (X=0.5, Y=0.2)) on the display screen 292 and the size of the window W2 (in the present embodiment, the width of the window W2 (W=0.5) and the height of the window W2 (H=0.6)) on the display screen 292. In the present embodiment, the transmitter 252 inputs the coordinates and sizes of the windows displayed on the display screen 292 as the layout information to the information processor 30. However, the transmitter 252 is not limited thereto so long as it inputs information on the layout of a plurality of windows on the display screen 292. For example, the transmitter 252 may also input information indicating the position of the window W2 on the display screen 292 in the horizontal direction or vertical direction with respect to the window W1 as the layout information to the information processor 30.

The value of the <version> tag in the <slot> tag indicates the version of the remote controlling application required for the control of the expansion card 10 connected to the expansion slot 21 (for example “1”).

The value of the <focus> tag in the <slot> tag indicates whether, when the expansion card 10 connected to the expansion slot 21 has a function of receiving a specific type of broadcasting, a window displaying the broadcast video of the broadcasting received by the expansion card 10 is an object to be operated (in other words, whether focus is placed thereon). For example, when focus is placed on the window W1 among the windows W1 and W2 displayed on the display screen 292 illustrated in FIG. 7B, the value of the <focus> tag in the <slot num=01> tag is “true,” and the value of the <focus> tag in the <slot num=02> tag is “false.”

Returning to FIG. 6, when receiving the expansion card list transmitted from the display device 20 (in other words, when the layout information of the windows on the display screen 292 of the display device 20 is input through the display device 20), the operating panel controller 371 of the information processor 30 compares the value of the <version> tag included in the expansion card list and the version of the started-up remote controlling application and executes processing for detecting the expansion card 10 that requires a remote controlling application of a later version than the version of the started-up remote controlling application (hereinafter called the version confirmation processing) (S604).

Upon detection of the expansion card 10 that requires the remote controlling application of a later version than the version of the started-up remote controlling application, the operating panel controller 371 causes the display screen 32 of the display module 31 to display a message indicating the necessity of version upgrading of the remote controlling application. The remote controlling application, which is an application for the information processor 30 such as a smartphone or a tablet terminal, is acquired from a server or the like on a network such as the Internet, not from the display device 20.

Upon no detection of the expansion card 10 that requires a remote controlling application of a later version than the version of the started-up remote controlling application, or upon acquisition of a remote controlling application of a later version, the operating panel controller 371 instructs the display device 20 to transmit the GUI information of the expansion card 10 connected to the expansion slot 21 with a slot number indicated by the attribute of the <slot> tag included in the expansion card list (S605). In the present embodiment, for each expansion slot 21 with a slot number indicated by the attribute of the <slot> tag included in the expansion card list, the operating panel controller 371 instructs to transmit the GUI information of the expansion card 10 connected to the expansion slot 21.

Upon receiving the instruction to transmit the GUI information from the information processor 30, the window controller 251 of the display device 20 transmits the received instruction to transmit the GUI information to the expansion card 10 through the Ethernet 41 and the Ethernet hub 23. The window controller 251 then acquires the GUI information from the expansion card 10 (S606). In the present embodiment, for each expansion card 10 connected to the expansion slots 21-1 and 21-2, the window controller 251 acquires the GUI information including the slot number of the expansion slot 21 to which the expansion card 10 is connected. Specifically, the GUI information includes layout information (arrangement information) indicating the layout (arrangement) of the operating panel displayed through the implementation of the GUI of the expansion card 10, the image data of buttons included in the operating panel of the expansion card 10, codes for identifying the buttons included in the operating panel of the expansion card 10.

More specifically, as illustrated in FIG. 8, GUI information 800 includes layout information 801 in the XML format that indicates the layout of the buttons or the like included in the operating panel of the expansion card 10 and codes to be transmitted when the buttons are pressed (operated), and image data 802 of the buttons included in the operating panel of the expansion card 10. Added to each image data 802 is an image code 803 that is an example of unique information for identifying the image data 802.

As illustrated in FIG. 8, the layout information 801 in the XML format includes the slot number (for example, “num=1”) of the expansion slot 21 to which the expansion card 10 whose GUI information was acquired is connected and a <slot> tag having an attribute of an ID (for example, “id=0001”) indicating the model number of the expansion card 10 connected to the expansion slot 21 with the slot number.

The <slot> tag includes an <area> tag that is the tag of the operating panel of the expansion card 10 and a <button> tag that is the tag of widgets such as the buttons included in the operating panel of the expansion card 10. The attribute of the <area> tag indicates the size of the operating panel of the expansion card 10 on the display screen 32 (in the present embodiment, the width of the operating panel of the expansion card 10 (W=1.0) and the height of the operating panel of the expansion card 10 (H=1.0)) and the color of the operating panel of the expansion card 10 (color=0xFF808080).

The attribute of the <button> tag indicates the coordinates of the top-left corner of a button on the operating panel of the expansion card 10 (for example, X=0.07, Y=0.07), the size of a button on the operating panel of the expansion card 10 (for example, the width of a button (W=0.16) and the height of a button (H=0.08)), and the image code of the image data of a button included in the operating panel of the expansion card 10 (for example, img=“Rewind.png”).

The <button> tag includes a <code> tag with a value of a code (for example, “0001”) to be transmitted to the display device 20 when a button included in the operating panel of the expansion card 10 is pressed.

Returning to FIG. 6, once acquired by the window controller 251, the GUI information is transmitted to the information processor 30 by the transmitter 252 (S607). This implements the GUI of the expansion card 10 in the information processor 30 in real time in accordance with the installation of the expansion card 10 in the display device 20.

Using the GUI information received from the display device 20, the operating panel controller 371 of the information processor 30 draws the operating panel of the expansion card 10 connected to the display device 20 on the storage module 36 and cause the display screen 32 of the display module 31 to display the operating panel drawn on the storage module 36 (S608). This allows the operating panel controller 371 to implement the GUI of the expansion card 10 connected to the expansion slot 21 of the display device 20.

In the present embodiment, as illustrated in FIG. 9, in accordance with the size of the operating panel of the expansion card 10 and the color of the operating panel of the expansion card 10 indicated by the attribute of the <area> tag in the <slot> tag of the layout information 801 included in the GUI information, the operating panel controller 371 draws a background image 900 of the widgets (for example, buttons) included in the operating panel of the expansion card 10 on the storage module 36.

In accordance with the coordinates of a button and the size of the button indicated by the <button> tag in the <slot> tag of the layout information 801 included in the GUI information, the operating panel controller 371 then draws an operating panel in which button images 901 to 907 based on the image data 802 indicated by the attribute of the <button> tag are arranged on the background image 900 on the storage module 36.

For example, as illustrated in FIG. 10, when drawing the button image 901 included in the operating panel of the expansion card 10 with the ID (“id=0001”) indicated by the attribute of the <slot> tag of the layout information 801 included in the GUI information, the operating panel controller 371 determines a rectangular area 1001 with the coordinates (X=0.07, Y=0.07) indicated by the attribute of the <button> tag of the button as its top-left coordinates and with the width of the button (W=0.16) and the height of the button (H=0.08) indicated by the attribute of the <button> tag of the button on the background image 900 drawn on the storage module 36. The operating panel controller 371 then draws the image 901 based on the image data 802 of an image code (“img=“Rewind.png”) indicated by the attribute of the <button> tag of the button on the determined rectangular area 1001.

In the present embodiment, the operating panel controller 371 draws the operating panel on the storage module 36 for each expansion card 10 with an ID indicated by the attribute of the <slot> tag of the layout information 801 included in the GUI information.

After causing the display screen 32 of the display module 31 to display the operating panel, when a button included in the operating panel is operated, the operating panel controller 371 transmits a value of the <code> tag (for example, “0001”) included in the <button> tag of the operated button among the layout information 801 included in the GUI information to the expansion card 10, thereby controlling the expansion card 10.

In the present embodiment, when the button included in the operating panel displayed on the display screen 32 is operated, the operating panel controller 371 transmits an event in the XML format including the value of the <code> tag included in the <button> tag of the operated button to the expansion card 10 through the Ethernet hub 23 of the display device 20.

For example, when the button with the <button> tag including the <code> tag of the value “0001” in the layout information 801 is pressed, as illustrated in FIG. 11, the operating panel controller 371 transmits to the expansion card 10 an event 1100 in the XML format including: a <slot> tag with a value of the slot number “num=1,” which is the attribute of the <slot> tag including the <button> tag of the pressed button in the layout information 801; a <device id> tag with an attribute of the ID “id=0001,” which is the attribute of the <slot> tag including the <button> tag of the pressed button; a <type> tag with a value of “Push Key,” which indicates that the button was pressed; and a <code> tag. The operating panel controller 371 thus transmits to the display device 20 control information that relates to the control of an external device using GUI and includes a slot number indicating the expansion slot 21 to which the expansion card 10 to be controlled using GUI is connected.

The Ethernet hub 23 (the communication module) of the display device 20 receives the control information from the information processor 30 and, in accordance with the slot number included in the received control information, transmits the received control information to the expansion card 10 connected to the expansion slot 21. Specifically, upon receiving the control information, the Ethernet hub 23 determines the internal IP address of the expansion card 10 using the slot number included in the received control information. For example, the Ethernet hub 23 determines the internal IP address of the expansion card 10, which is an object to be controlled, to be a value “192.0.2.2” obtained by adding the slot number “1” included in the received control information to the fourth value “1” of the IP address eth0=″192.0.2.1″ of the display device 20. The Ethernet hub 23 then transmits the received control information to the expansion card 10 with the determined IP address. The information processor 30 can thereby control the expansion card 10 through the display device 20.

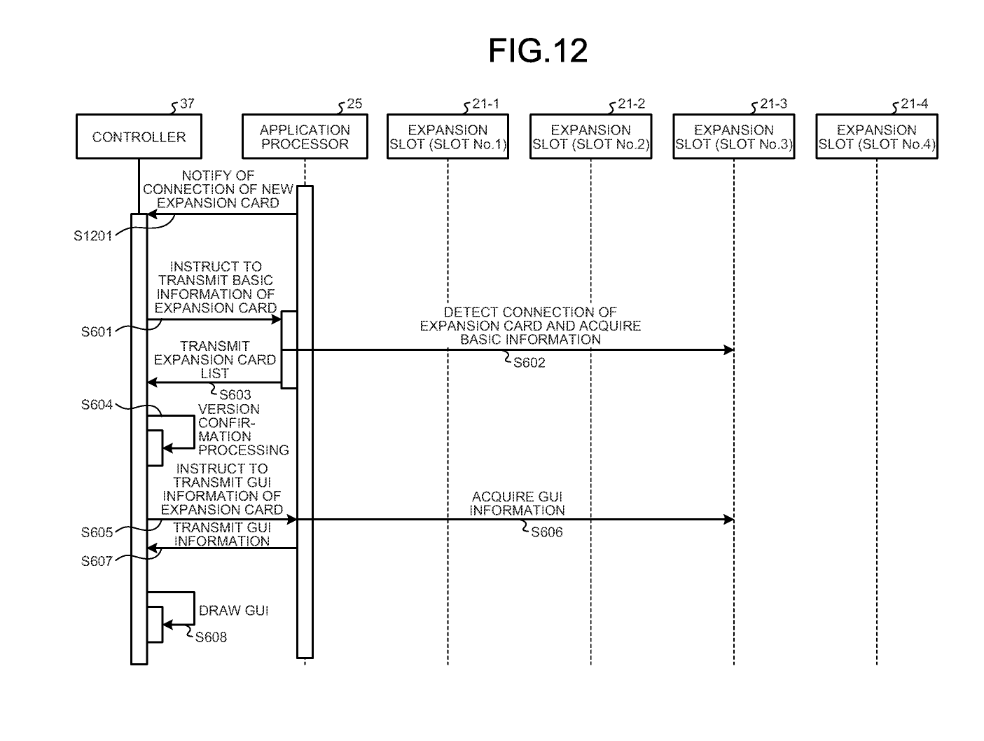

Described next with reference to FIG. 5 and FIG. 12 is processing that, in a case in which a new expansion card 10 is connected to the display device 20, allows the information processor 30 to implement the GUI of the new expansion card 10. FIG. 12 is a sequence diagram illustrating the flow of processing that allows the information processor to implement the GUI of the new expansion card in the display control system in the first embodiment.

The window controller 251 of the display device 20 detects, through the port processor 24, the connection of the expansion card 10 to the expansion slot 21 periodically while the IP address of the information processor 30 is stored in the DDR SDRAM 28 and registered in the information processor 30. Upon detecting the connection of the new expansion card 10 to the expansion slot 21-3, the application processor 25 informs the information processor 30 of the connection of the new expansion card 10 (S1201).

Once informed of the connection of the new expansion card 10, the application processor 25 and the controller 37 perform processing that implements the GUI of the new expansion card 10 in the same manner as at S601 to S608 in FIG. 6.

Although not illustrated, when the connection of the expansion card 10 to the expansion slot 21 is no longer detected, the transmitter 252 transmits end information to end the GUI implemented in the information processor 30 (the GUI of the expansion card 10 whose connection is no longer detected) to the information processor 30 through the Ethernet hub 23. This ends the GUI implemented in the information processor 30 in real time in accordance with the removal of the expansion card 10 from the expansion slot 21. In the present embodiment, when the connection of the expansion card 10 to the expansion slot 21 is no longer detected, the transmitter 252 transmits information indicating that the connection of the expansion card 10 has been released as end information to the information processor 30.

When receiving the end information from the display device 20, the operating panel controller 371 of the information processor 30 ends the display of the expansion card 10 whose connection has been released on the display screen 32 of the operating panel.

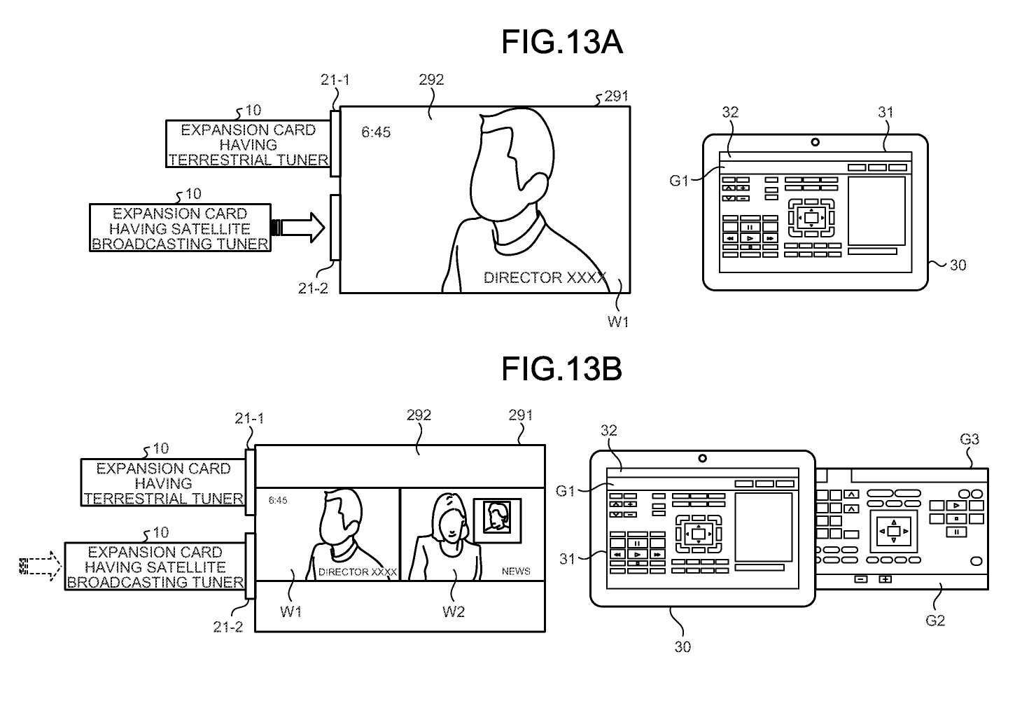

Described next with reference to FIGS. 13A and 13B is processing that implements the GUIs of a plurality of expansion cards 10 in the information processor 30. FIGS. 13A and 13B are diagrams for illustrating processing that implements the GUIs of a plurality of expansion cards in the information processor of the display control system in the first embodiment.

For example, when the expansion card 10 (the expansion card 10 having a terrestrial tuner capable of receiving terrestrial television broadcasting) is connected only to the expansion slot 21-1, the CPU 26 of the application processor 25 receives, through the port processor 24, the broadcast data of broadcasting received by the expansion card 10 connected to the expansion slot 21-1. As illustrated in FIG. 13A, the window controller 251 then outputs the received broadcast data to the panel controller 29 and causes the display screen 292 of the display module 291 to display the window W1 of the broadcast video included in the received broadcast data.

As illustrated in FIG. 13A, the operating panel controller 371 of the information processor 30 causes the display screen 32 of the display module 31 to display an operating panel G1 of the GUI of the expansion card 10 (the operating panel G1 corresponding to the window W1) connected to the expansion slot 21 using the GUI information transmitted from the transmitter 252, thereby implementing the GUI of the expansion card 10 connected to the expansion slot 21.

Thereafter, when a new expansion card 10 (an expansion card 10 having a satellite broadcasting tuner capable of receiving BS television broadcasting) is connected to the expansion slot 21-2, the CPU 26 receives, through the port processor 24, the broadcast data of broadcasting received by the expansion card 10 connected to the expansion slot 21-1 and the broadcast data of broadcasting received by the expansion card 10 connected to the expansion slot 21-2. As illustrated in FIG. 13B, the window controller 251 then outputs the broadcast data of the received two pieces of broadcasting to the panel controller 29 and causes the display screen 292 of the display module 291 to simultaneously display the windows W1 and W2 of the broadcast video included in the respective pieces of broadcast data of the two pieces of broadcasting.

As illustrated in FIG. 13B, the operating panel controller 371 of the information processor 30 causes the display screen 32 of the display module 31 to display at least either one of the operating panel G1 of the expansion card 10 connected to the expansion slot 21-1 (the operating panel G1 corresponding to the window W1) and an operating panel G2 of the expansion card 10 connected to the expansion slot 21-2 (the operating panel G2 corresponding to the window W2) using the GUI information of the respective two expansion cards 10 transmitted from the transmitter 252, thereby implementing the GUIs of the two respective expansion cards 10 connected to the expansion slots 21-1 and 21-2.

In the present embodiment, upon receiving the GUI information of a respective plurality of expansion cards 10 from the transmitter 252, the operating panel controller 371 causes the display screen 32 to display an image to be displayed, which contains at least one operating panel included in an image (hereinafter called the virtual entire image) that is larger than the display size of the display screen 32 and includes the operating panels of the respective expansion cards 10 (the operating panels corresponding to the respective windows displayed on the display screen 292 of the display device 20). When an operation instructing the switching of the image to be displayed (for example, an operation of dragging the display screen 32) is input through the input module 38, the operating panel controller 371 switches the operating panel to be displayed on the display screen 32 within the virtual entire image.

For example, upon receipt of the GUI information of the two respective expansion cards 10 from the transmitter 252, as illustrated in FIG. 13B, the operating panel controller 371 stores in the storage module 36 a virtual entire image G3 that is drawn larger than the display size of the display screen 32 and includes the operating panels G1 and G2 of the respective two expansion cards 10 whose GUI information has been received. The operating panel controller 371 then causes the display screen 32 to display a portion of the drawn virtual entire image G3 stored in the storage module 36 (for example, an image including at least either one of the two operating panels G1 and G2). In this regard, the operating panel controller 371 may cause the display screen 32 to display an operating panel corresponding to a window to be operated on the display screen 292 of the display device 20 from among the two operating panels G1 and G2 included in the virtual entire image G3.

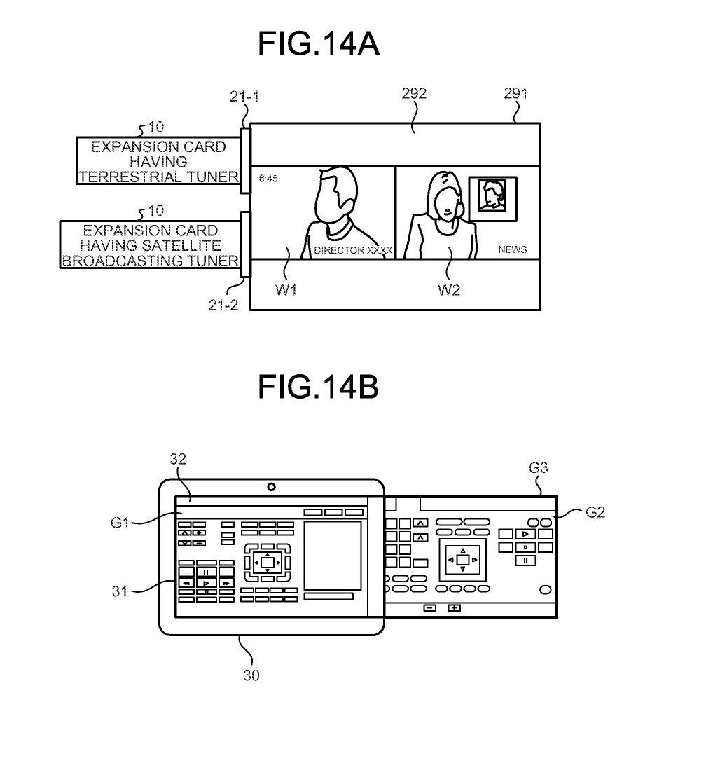

Described next with reference to FIGS. 14A and 14B are the layouts (arrangements) of an operating panel displayed on the display screen 32 of the information processor 30. FIGS. 14A and 14B are diagrams for illustrating the layout of an operating panel displayed on a display screen of the information processor in the first embodiment.

When causing the display screen 32 to display a plurality of operating panels corresponding to a respective plurality of windows displayed in the display screen 292 of the display device 20 (in other words, the operating panels of a respective plurality of expansion cards 10 capable of receiving the broadcast data of broadcast videos to be displayed on the windows), the operating panel controller 371 brings the layout of the operating panels close to the layout of the windows corresponding to the operating panels based on the layout information included in the received expansion card list. Bringing the layout of the operating panels close to the layout of the windows corresponding to the operating panels is to make the layout (the manner of layout) of the operating panels and the layout (the manner of layout) of the windows corresponding to the operating panels the same in appearance so that the correspondence relation between the layout of the operating panels and the windows corresponding to the operating panels can be intuitively understood. In other words, the operating panel controller 371 makes the layout of the operating panels and the layout of the windows corresponding to the operating panels the same (nearly the same or similar). However, it is not necessary that the layout of the operating panels and the layout of the windows corresponding to the operating panels are identical (exactly the same).

In the present embodiment, based on the layout information included in the expansion card list received from the display device 20, the operating panel controller 371 first determines the position relation among a plurality of windows on which broadcast videos included in broadcast data received by a respective plurality of expansion cards 10 connected to the expansion slot 21. Based on the determined position relation among the windows, the operating panel controller 371 then brings the layout (arrangement) of the operating panels corresponding to the respective windows (in the present embodiment, the operating panels of the expansion cards 10 that receive the broadcast data of the broadcast videos to be displayed on the respective windows) close to the layout (arrangement) of the windows.

For example, as illustrated in FIG. 14A, when the expansion card 10 (the expansion card 10 having a terrestrial tuner capable of receiving terrestrial television broadcasting) is connected to the expansion slot 21-1, and the expansion card 10 (the expansion card 10 having a satellite broadcasting tuner capable of receiving BS television broadcasting) is connected to the expansion slot 21-2, the window controller 251 of the display device 20 causes the display screen 292 to display the window W1 displaying a broadcast video included in the broadcast data of the terrestrial television broadcasting received by the expansion slot 21-1 and the window W2 displaying a broadcast video included in the broadcast data of the BS television broadcasting received by the expansion slot 21-2. The transmitter 252 of the display device 20 transmits the expansion card list including the basic information of the expansion cards 10 connected to the respective expansion slots 21-1 and 21-2 to the information processor 30, thereby receiving the layout information of the windows G1 and G2 to the information processor 30.

Based on the layout information input through the display device 20, the operating panel controller 371 of the information processor 30 determines that the window W2 is positioned on the right side of the window W1 on the display screen 292 of the display device 20. The operating panel controller 371 then arranges the operating panel G2 corresponding to the window W2 (the operating panel G2 of the expansion card 10 that receives the broadcast data of the broadcast video displayed on the window W2) on the right side of the operating panel G1 corresponding to the window W1 (the operating panel G1 of the expansion card 10 that receives the broadcast data of the broadcast video displayed on the window W1) on the display screen 32 of the information processor 30. The operating panel controller 371 thereby brings the layout of the operating panels G1 and G2 corresponding to the windows W1 and W2, respectively, close to the layout of the windows W1 and W2 displayed on the display screen 292 of the display device 20. This allows the user of the information processor 30 to intuitively understand which of the operating panels G1 and G2 on the display screen 32 of the information processor 30 is the operating panel corresponding to which of the windows W1 and W2, while viewing the layout of the windows W1 and W2 on the display screen 292 of the display device 20.

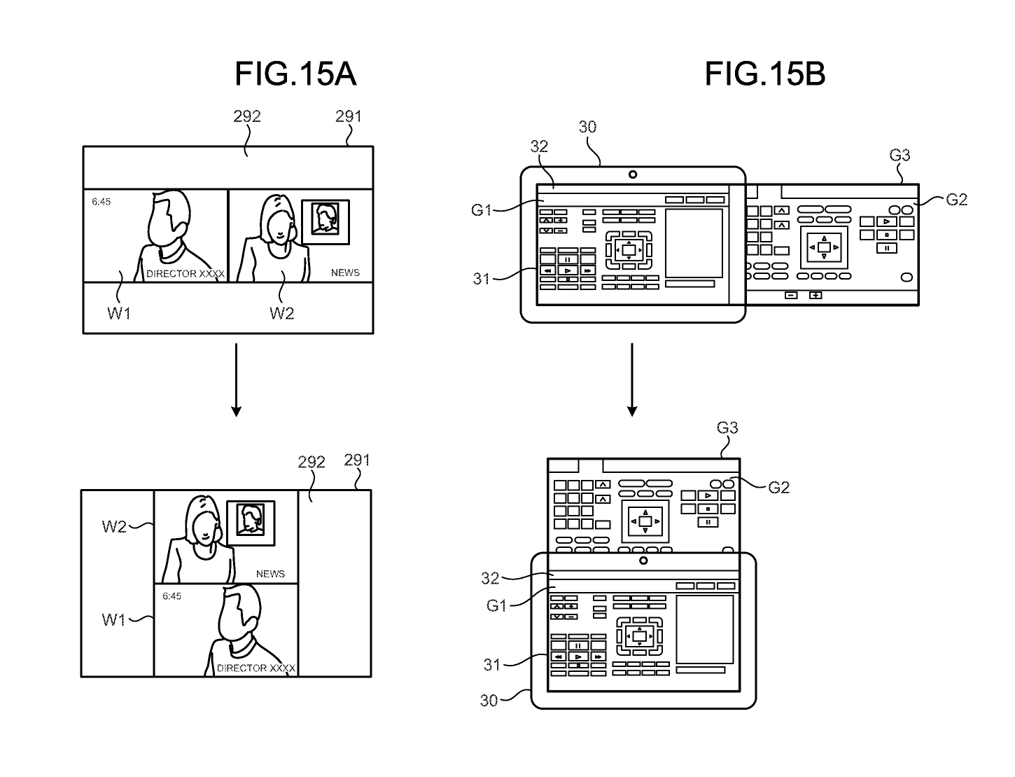

Described next with reference to FIGS. 15A and 15B is processing that changes the layout of operating panels displayable on the display screen 32 of the information processor 30 in accordance with a change in the layout of a plurality of windows displayed on the display screen 292 of the display device 20. FIGS. 15A and 15B are diagrams for illustrating processing that changes the layout of an operating panel displayable on the display screen of the information processor in the display control system in the first embodiment.

When the layout of the windows displayed on the display screen 292 is changed by an external device (for example, an IR remote controller that comes with the display device 20) other than the information processor 30 that displays operating panels corresponding to the windows displayed on the display screen 292, the transmitter 252 of the display device 20 transmits (inputs) the changed layout information of the windows to the information processor 30. This changes the layout of the operating panels corresponding to the respective windows whose layout was changed. In the present embodiment, the window controller 251 of the display device 20 acquires the basic information of the expansion card 10 including the changed layout information of the windows from the expansion card 10 connected to the expansion slot 21 each time the layout of the windows displayed on the display screen 292 is changed. The transmitter 252 transmits an expansion card list including the acquired basic information to the information processor 30.

The operating panel controller 371 of the information processor 30 changes the layout of the operating panels displayed on the display screen 32 of the information processor 30 to bring it close to the layout of the windows corresponding to the operating panels based on the input layout information each time the changed layout information of the window is transmitted (input) from the display device 20. A method for arranging the operating panels based on the input layout information is the same as the above-described method for arranging the operating panels.

For example, when the layout of the window W2 is changed to be positioned above the window W1 on the display screen 292 of the display device 20 (see FIG. 15A), the operating panel controller 371 changes the layout of the operating panel G2 corresponding to the window W2 to be positioned above the operating panel G1 corresponding to the window W1 on the display screen 32 (see FIG. 15B).

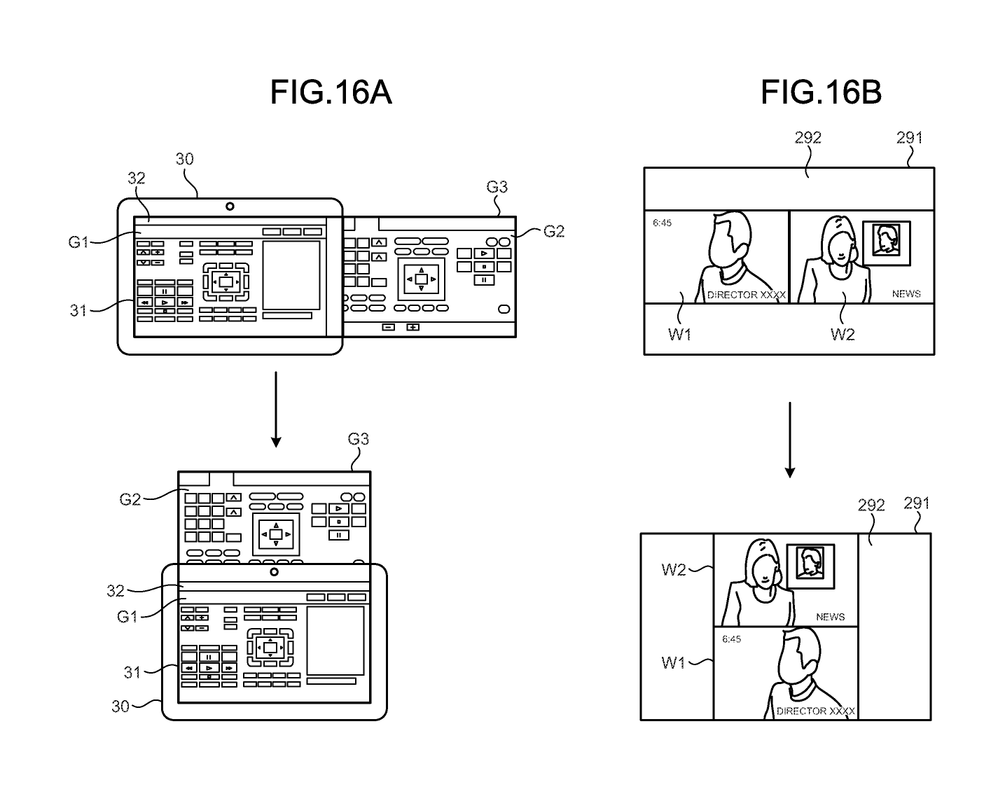

Described next with reference to FIGS. 16A and 16B is processing that changes the layout of a plurality of windows displayed on the display screen 292 of the display device 20 in accordance with a change in the layout of a plurality of operating panels displayable on the display screen 32 of the display module 31. FIG. 16 is a diagram for illustrating processing that changes the layout of a plurality of windows displayed on the display screen of the display device in the display control system in the first embodiment.

When the layout of the operating panels displayable on the display screen 32 is changed in accordance with an operation input through the input module 38, the operating panel controller 371 of the information processor 30 transmits a change instruction to the display device 20. The change instruction instructs a change in the layout of the windows displayed on the display screen 292 of the display device 20 to arrange them in a layout that is close to the changed layout of the operating panels. In the present embodiment, when the layout of the operating panels displayable on the display screen 32 is changed in accordance with the operation input through the input module 38, the operating panel controller 371 transmits to the display device 20 a change instruction including operating panel layout information indicating the changed layout of the operating panels.

For example, when the layout of the operating panel G2 is changed to be positioned above the operating panel G1 on the display screen 32 in accordance with the operation input through the input module 38 (see FIG. 16A), the operating panel controller 371 transmits a change instruction including operating panel layout information indicating that the layout of the operating panel G2 is positioned above the operating panel G1 on the display screen 32 to the display device 20.

Upon receipt of the change instruction from the information processor 30, based on the operating panel layout information included in the received change instruction, the window controller 251 of the display device 20 brings the layout of the windows corresponding to the respective operating panels close to the changed layout of the operating panels. For example, when the operating panel layout information included in the received change instruction indicates that the layout of the control panel G2 has been changed to be positioned above the operating panel G1 on the display screen 32 of the information processor 30 (see FIG. 16A), the window controller 251 changes the window W2 corresponding to the operating panel G2 to be positioned above the window W1 corresponding to the operating panel G1 on the display screen 292 (see FIG. 16B). This allows the user of the information processor 30 to intuitively recognize what operation causes the display screen 32 to display a desired operating panel by recognizing the layout of the windows W1 and W2 displayed on the display screen 292 of the display device 20.

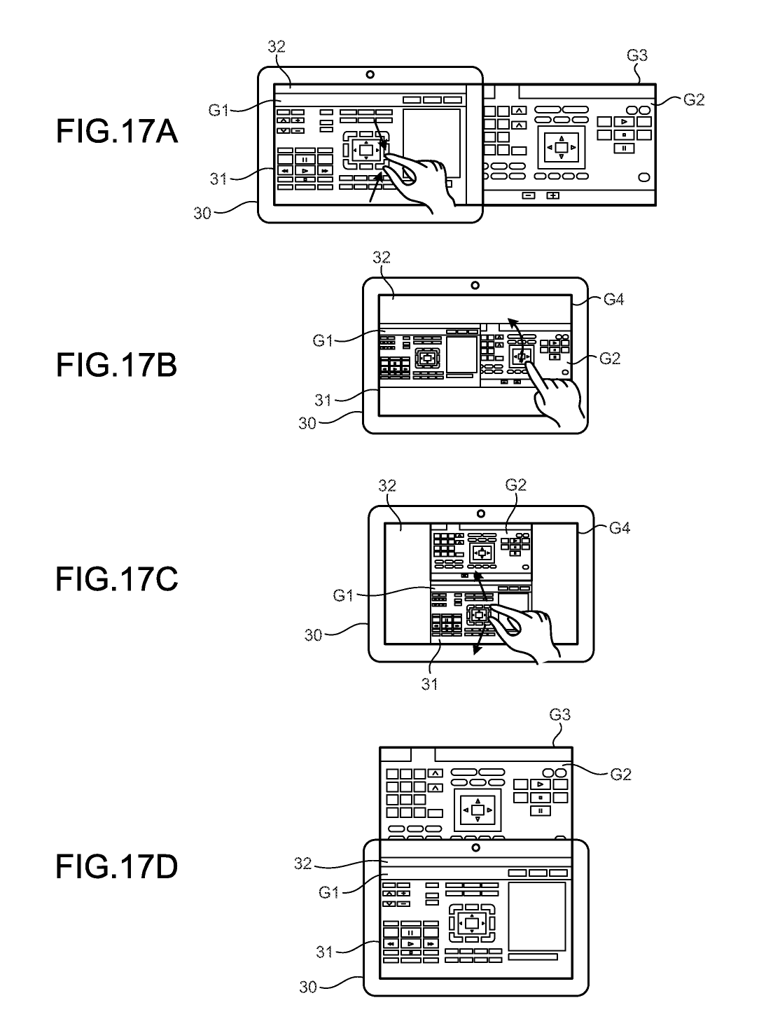

Described next specifically with reference to FIGS. 17A to 17D is processing that changes the layout of operating panels displayable on the display screen 32 of the information processor 30. FIGS. 17A to 17D are diagrams for illustrating processing that changes the layout of operating panels in the information processor in the first embodiment.

When an operation is input through the input module 38 to move either one operating panel among a plurality of operating panels displayable on the display screen 32 to a desired position, the operating panel controller 371 of the information processor 30 moves the either one operating panel to the desired position, thereby changing the layout of the operating panels displayable on the display screen 32.

In the present embodiment, in an operation mode in which at least either one operating panel (for example, the operating panel G1) within the virtual entire image G3 is displayed operable on the display screen 32, when a pinch-in operation is input through the input module 38 (see FIG. 17A), the operating panel controller 371 switches to a layout change mode in which the layout of the operating panel can be changed. Having switched to the layout change mode, the operating panel controller 371 causes the display screen 32 to display an image of the entire virtual entire image G3 scaled to the size of the display screen 32 as an image G4 for layout change use (see FIG. 17B). In the present embodiment, after switching to the layout change mode, the operating panel controller 371 prohibits the operation of the operating panels G1 and G2 included in the image G4 for layout change use. This can prevent any misoperation on the operating panels G1 and G2 through a touch on the operating panels G1 and G2 included in the image G4 for layout change use in the layout change mode.

In the layout change mode, when an operation is input through the input module 38 to move either one operating panel (for example, the operating panel G2) among the operating panels included in the image G4 for layout change use to a desired position (for example, above the operating panel G1) (see FIG. 17B), the operating panel controller 371 moves the operating panel G2 to be placed above the operating panel G1, thereby changing the layout of the operating panels G1 and G2 included in the image G4 for layout change use (see FIG. 17C). Thereafter, when a pinch-out operation is input through the input module 38 (see FIG. 17C), the operating panel controller 371 switches from the layout change mode to the operation mode and causes the display screen 32 to display the virtual entire image G3 that includes the operating panels G1 and G2 with their layout changed and is larger than the display size of the display screen 32 (see FIG. 17D).

In the present embodiment, after switching to the layout change mode, the operating panel controller 371 prohibits the operation of the operating panels G1 and G2 included in the image G4 for layout change use. However, without being limited thereto, even after switching to the layout change mode, the operation of the operating panels G1 and G2 included in the image G4 for layout change use may be allowed, and the operating panels G1 and G2 may be operable simultaneously. In the present embodiment, the operating panel controller 371 can change the layout of operating panels after switching to the layout change mode. However, without being limited thereto, even after switching to the operation mode, the layout of operating panels displayable on the display screen 32 may be changed.

As described above, the layout information on the layout of a plurality of windows displayed on the display screen 292 of the display device 20 is input through the display device 20. Based on the input layout information, the information processor 30 of the present embodiment brings the layout of a plurality of operating panels displayable on the display screen 32 of the information processor 30 and corresponding to the respective windows close to the layout of the windows corresponding to the operating panels, thereby allowing the windows displayed on the display device 20 to be operated by the information processor 30 simultaneously and intuitively.

### First Modification

A first modification is an example in which an operating panel displayed on the display screen 32 of the information processor 30 is switched in accordance with the tilt of the information processor 30. The following description omits a description of the same parts as in the first embodiment.

In the present modification, the operating panel controller 371 of the information processor 30 assumes that the virtual entire image is arranged on a virtual plane including the display screen 32. When a tilt of the information processor 30 is detected by the motion sensor 33 (an example of a first detector), the operating panel controller 371 slides an operating panel that is positioned above the operating panel displayed on the display screen 32 among the operating panels included in the virtual entire image into the display screen 32 and changes the operating panels. This enables switching of the operating panel displayed on the display screen 32 as if gravity acts on the virtual entire image, thereby performing the switching of the operating panel displayed on the display screen 32 intuitively.

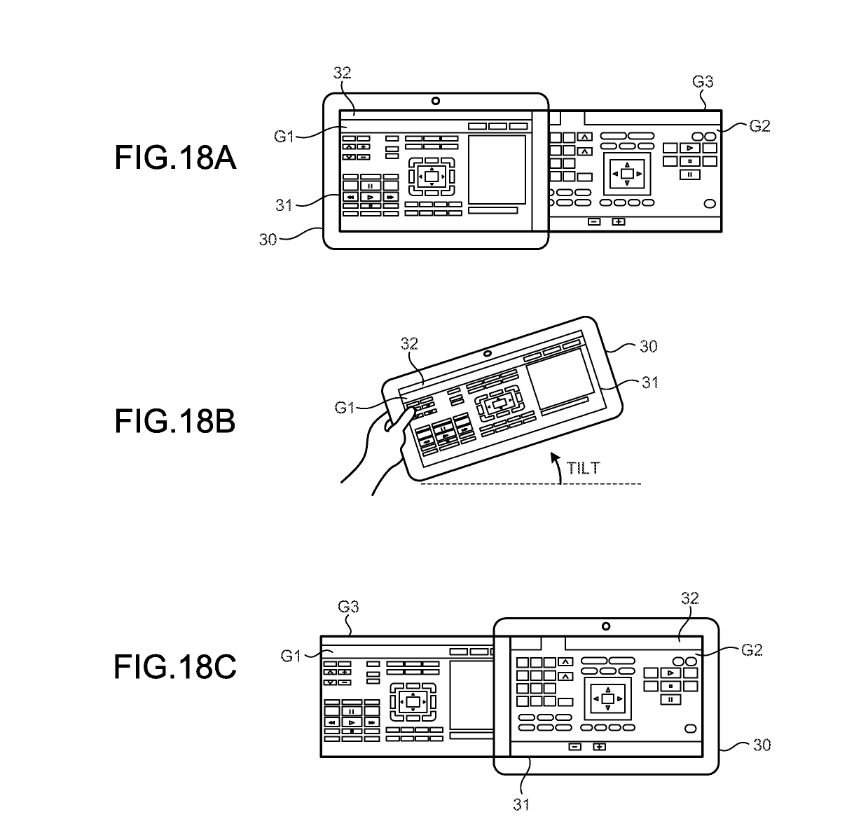

FIGS. 18A to 18C are diagrams for explaining processing that changes an operating panel displayed on a display screen of an information processor according to the first modification. For example, in a situation in which the information processor 30 is in the operation mode and the operating panel G1 included in the virtual entire image G3 is displayed on the display screen 32 (see FIG. 18A), when a tilt of the information processor 30 is detected by the motion sensor 33 (see FIG. 18B), the operating panel controller 371 determines whether the operating panel G2 is above the operating panel G1 on the virtual entire image G3 (in other words, in the real space).

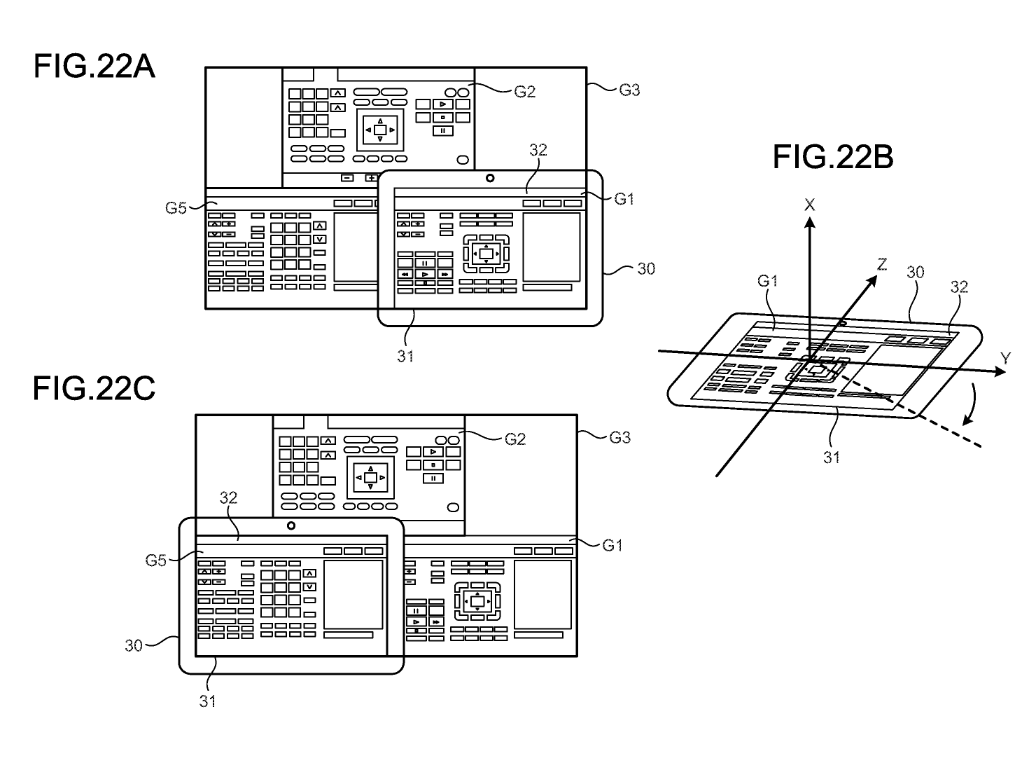

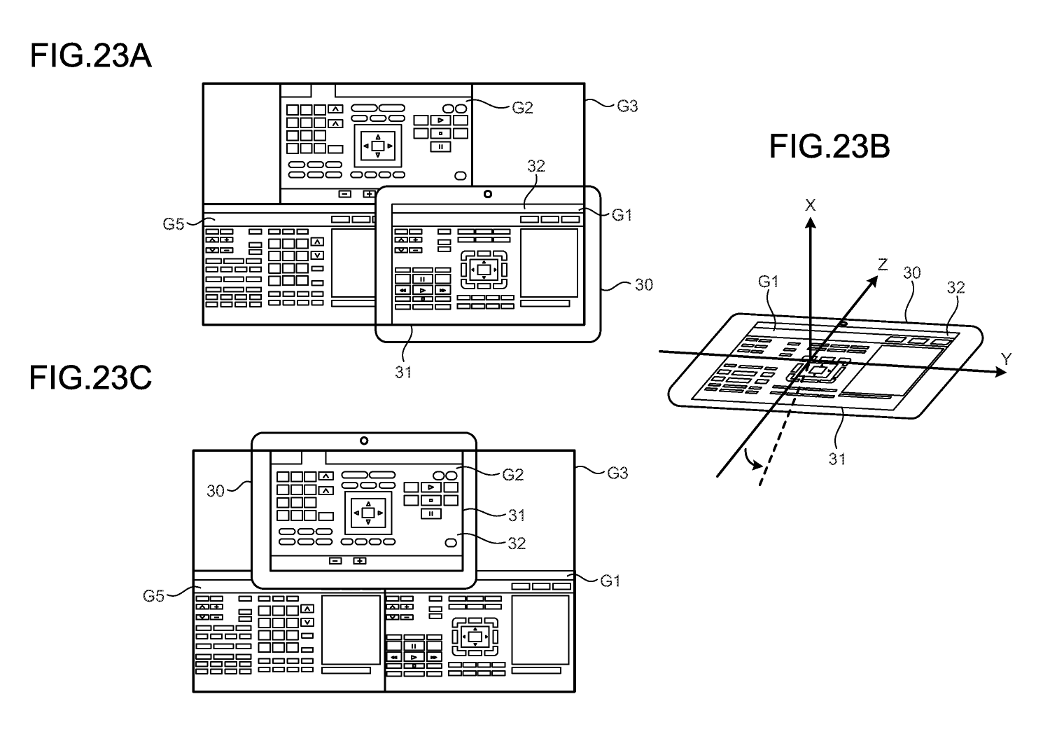

Specifically, the operating panel controller 371 determines that the operating panel G2 is above the operating panel G1, when determining that the lowermost corner among the corners of the operating panel G1 is below the lowermost corner among the corners of the operating panel G2. Alternatively, the operating panel controller 371 may determine that the operating panel G2 is above the operating panel G1, when determining that the gravity center of the operating panel G1 is below the gravity center of the operating panel G2. Alternatively, the operating panel controller 371 may determine that operating panel G2 is above the operating panel G1, based on gravitational acceleration in biaxial directions that are parallel to the display screen 32 and orthogonal to each other (the Y-axis and Z-axis, see FIG. 22B and FIGS. 23B).

Upon determination that the operating panel G2 is above the operating panel G1 on the virtual entire image G3, as illustrated in FIG. 18C, the operating panel controller 371 slides the operating panel G2 that is above the operating panel G1 displayed on the display screen 32 among the operating panels G1 and G2 included in the virtual entire image G3 into the display screen 32 and switches to the operating panel G2. The operating panel controller 371 may increase the acceleration when sliding the operating panel G2 to replace the operating panel G1 displayed on the display screen 32 in accordance with the tilt of the information processor detected by the motion sensor 33. The operating panel controller 371 may switch the operating panel displayed on the display screen 32 when the tilt of the information processor 30 detected by the motion sensor 33 is not less than a predetermined angle (for example, 45 degrees), thereby preventing the operating panel from being switched by a tilt resulting from a normal operation of the information processor 30.

As described above, the present modification can switch the operating panel displayed on the display screen 32 as if gravity acts on the virtual entire image by switching the operating panel displayed on the display screen 32 in accordance with the tilt of the information processor 30, thereby performing the switching of the operating panel displayed on the display screen 32 intuitively.

### Second Modification

A second modification is an example in which a layout direction (arrangement direction) of a plurality of operating panels rotates in accordance with the rotation of the information processor 30 about the axis of rotation perpendicular to the display screen 32 of the information processor 30. The following description omits a description of the same parts as in the first embodiment.

In the present modification, the motion sensor 33 (a second detector) detects angular acceleration resulting from the rotation of the information processor 30 about the axis of rotation perpendicular to the display screen 32 of the information processor 30 (for example, the X-axis illustrated in FIG. 22B and FIGS. 23B). When, following the detection of angular acceleration resulting from the rotation of the information processor 30 in a first direction, angular acceleration is detected that is larger than predetermined angular acceleration and results from the rotation of the information processor 30 in a second direction opposite the first direction, the operating panel controller 371 of the information processor 30 rotates the layout direction of the operating panels by 90 degrees in the first direction. This can make the layout direction of the operating panels displayable on the display screen 32 appear to have been changed by the moment of inertia resulting from the rotation of the information processor 30. In the present embodiment, the operating panel controller 371 rotates the layout direction of the operating panels in the first direction by 90 degrees. However, without being limited thereto, the operating panel controller 371 has only to make the layout direction of the operating panels displayable on the display screen 32 appear to have been changed by the moment of inertia resulting from the rotation of the information processor 30.

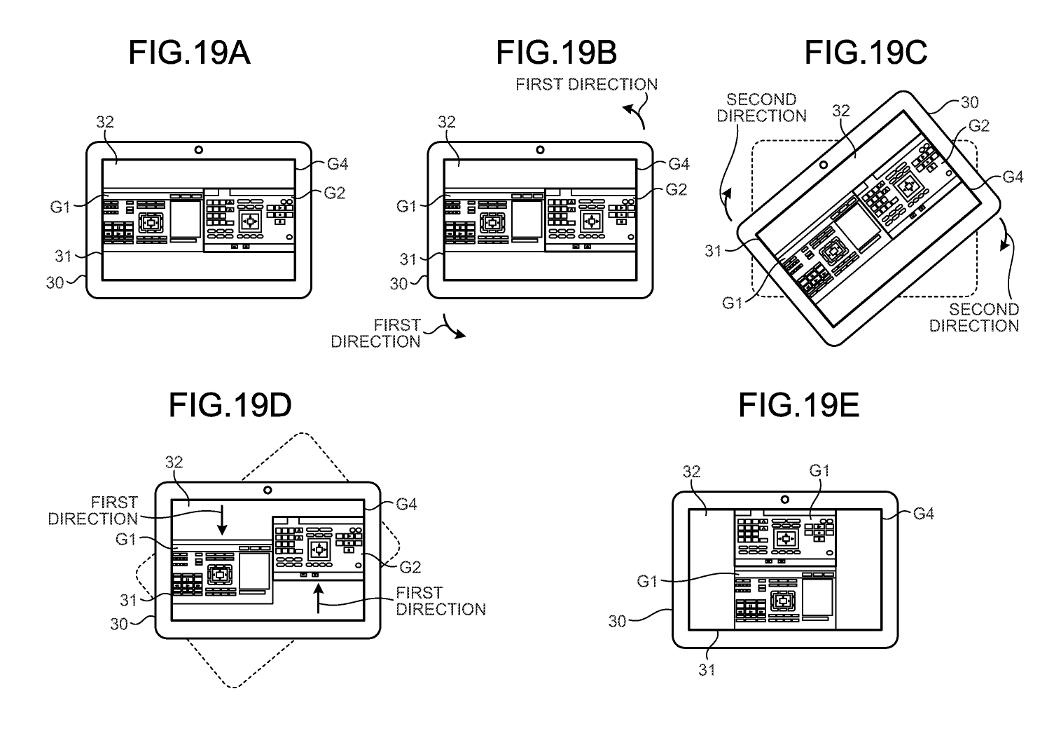

FIGS. 19A to 19E are diagrams for illustrating processing that changes the layout direction of a plurality of operating panels in an information processor according to the second modification. For example, when the information processor 30 is in the layout change mode (see FIG. 19A), and when, following the detection of angular acceleration resulting from the rotation of the information processor 30 in a first direction (for example, counterclockwise), angular acceleration resulting from the rotation of the information processor 30 in a second direction opposite the first direction (for example, clockwise) is detected (see FIGS. 19B and C), the operating panel controller 371 rotates the layout direction of the operating panels G1 and G2 in the first direction by 90 degrees (see FIG. 19D). The operating panel controller 371 thereby changes the layout direction of the operating panels G1 and G2 from the horizontal direction to the vertical direction as illustrated in FIG. 19E.

As described above, the present modification can rotate the layout direction of the operating panels in accordance with the rotation of the information processor 30 about the axis of rotation perpendicular to the display screen 32 of the information processor 30. This can make the layout direction of the operating panels displayable on the display screen 32 appear to have been changed by the moment of inertia resulting from the rotation of the information processor 30.

### Third Modification

A third modification is an example in which the display screen 32 displays position information on the position of an operating panel other than an operating panel displayed on the display screen 32 (an image to be displayed) within the virtual entire image. The following description omits a description of the same parts as in the first embodiment.

In the present modification, the operating panel controller 371 of the information processor 30 causes the display screen 32 to display at least any one operating panel (an image to be displayed) within the virtual entire image and position information on the positions of operating panels other than the image to be displayed. As a result of this, it can be recognized where the operating panels other than the image to be displayed are positioned, thereby facilitating the switching of the operating panel displayed on the display screen 32. In accordance with an operation of tapping the position information displayed on the display screen 32, the operating panel controller 371 can also switch the image to be displayed on the display screen 32 to the operating panel that is present at the position indicated by the tapped position information.

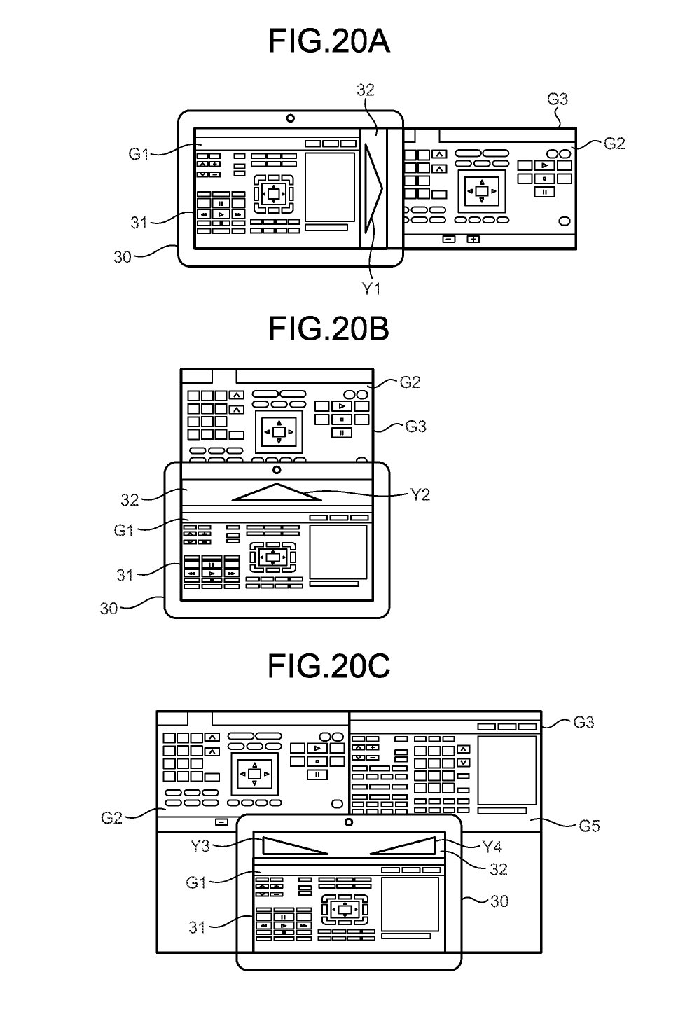

FIGS. 20A to 20C is a diagram illustrating a display example of position information on a display screen of an information processor according to the third modification. For example, as illustrated in FIG. 20A, when the display screen 32 displays the operating panel G1 within the virtual entire image G3 on which the operating panels G1 and G2 are arranged in the horizontal direction, the operating panel controller 371 causes the display screen 32 to display an arrow Y1 (an example of the position information) indicating a direction in which the operating panel G2 is present with respect to the operating panel G1 (the right direction with respect to the operating panel G1 on the display screen 32).

As illustrated in FIG. 20B, when the display screen 32 displays the operating panel G1 within the virtual entire image G3 on which the operating panels G1 and G2 are arranged in the vertical direction, the operating panel controller 371 causes the display screen 32 to display an arrow Y2 (an example of the position information) indicating a direction in which the operating panel G2 is present with respect to the operating panel G1 (the upward direction with respect to the operating panel G1 on the display screen 32).

As illustrated in FIG. 20C, when the display screen 32 displays the operating panel G1 within the virtual entire image G3 on which the operating panel G2 and an operating panel G5 are arranged side by side above the operating panel G1, the operating panel controller 371 causes the display screen 32 to display, with respect to the operating panel G1, an arrow Y3 (an example of the position information) indicating a direction in which the operating panel G2 is present (the upper-left direction with respect to the operating panel G1 on the display screen 32) and an arrow Y4 (an example of the position information) indicating a direction in which the operating panel G5 is present (the upper-right direction with respect to the operating panel G1 on the display screen 32).

In the present embodiment, the display screen 32 displays arrows that indicate a total of eight directions with respect to the operating panel displayed on the display screen 32 (the image to be displayed) including the upward direction, downward direction, right direction, left direction, upper-right direction, lower-right direction, upper-left direction, and lower-left direction. In the present modification, for each direction in which an operating panel other than the operating panel displayed on the display screen 32 (the image to be displayed) is positioned, an arrow indicating the direction in which the operating panel other than the image to be displayed is displayed as the position information. However, for each operating panel other than the image to be displayed, an arrow indicating a direction in which the operating panel is positioned may be displayed as the position information.

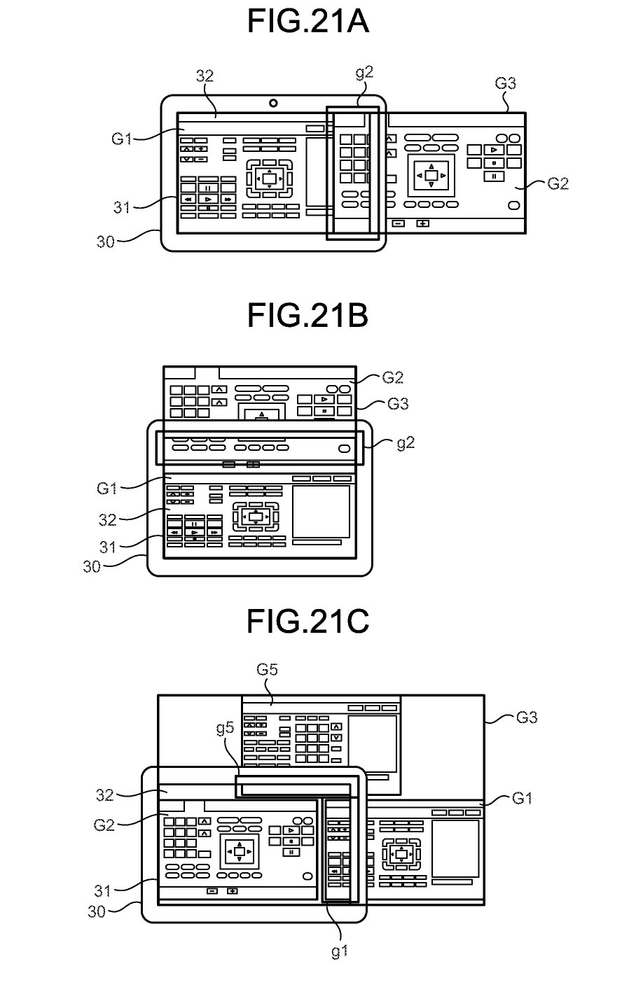

FIGS. 21A to 21C are diagrams illustrating another display example of position information on the display screen of the information processor in the third modification. For example as illustrated in FIG. 21A, when the display screen 32 displays the operating panel G1 within the virtual entire image G3 on which the operating panels G1 and G2 are arranged in the horizontal direction, the operating panel controller 371 causes the display screen 32 to display, on the display screen 32, a part g2 (an example of the position information) of the operating panel G2 positioned on the right side of the operating panel G1 within the virtual entire image G3.

As illustrated in FIG. 21B, when the display screen 32 displays the operating panel G1 within the virtual entire image G3 on which the operating panels G1 and G2 are arranged in the vertical direction, the operating panel controller 371 causes the display screen 32 to display a portion g2 (an example of the position information) of the operating panel G2 positioned above the operating panel G1 within the virtual entire image G3 on the display screen 32.

As illustrated in FIG. 21C, when the display screen 32 displays the operating panel G2 within the virtual entire image G3 on which the operating panel G1 is arranged on the right side of the operating panel G2 and the operating panel G5 is arranged above the operating panel G2, the operating panel controller 371 causes the display screen 32 to display a part g1 (an example of the position information) of the operating panel G1 present on the right side of the operating panel G2 and a portion g5 (an example of the position information) of the operating panel G5 present above the operating panel G2 within the virtual entire image G3 on the display screen 32.

In the present modification, when the display screen 32 displays a part of an operating panel other than the image to be displayed within the virtual entire image as the position information, buttons or the like displayed on the part of the operating panel displayed on the display screen 32 cannot be operated. As a result of this, an unintentional operating panel is prevented from being operated by mistake through a touch on an operating panel other than the image to be displayed.

As described above, the present modification causes the display screen 32 to display the position information on the position of an operating panel other than the operating panel displayed on the display screen 32 (the image to be displayed) within the virtual entire image. As a result of this, it can be recognized where the operating panel other than the image to be displayed within the virtual entire image is positioned, thereby facilitating the switching of the operating panel to be displayed on the display screen 32.

### Fourth Modification

A fourth modification is an example in which, when three operating panels are included in the virtual entire image, the operating panel displayed on the display screen 32 (the image to be displayed) is switched in accordance with a tilt of the information processor 30. The following description omits a description of the same parts as in the first embodiment.

FIGS. 22A to 22C and FIGS. 23A to 23C are diagrams for illustrating processing that switches an operating panel displayed on a display screen of an information processor according to the fourth modification. The operating panel controller 371 causes the display screen 32 to display any one operating panel within the virtual entire image G3 including the operating panels G1 and G5 arranged in the horizontal direction and the operating panel G2 arranged above the operating panels G1 and G5 (see FIG. 22A). When the information processor 30 rotates about the Z-axis and its tilt is detected by the motion sensor 33 (see FIG. 22B), the operating panel controller 371 causes the display screen 32 to display the operating panel G5 positioned above the operating panel G1 along the Y-axis with respect to the image to be displayed (the operating panel G1) as the image to be displayed (see FIG. 22C).

In a situation in which the display screen 32 displays the operating panel G1 within the virtual entire image G3 (see FIG. 23A), when the information processor rotates about the Y-axis and its tilt is detected by the motion sensor 33 (see FIG. 23B), the operating panel controller 371 causes the display screen 32 to display the operating panel G2 positioned above the operating panel G1 along the Z-axis with respect to the image to be displayed (the operating panel G1) as the image to be displayed (see FIG. 23C).

As described above, the present modification allows switching of the operating panel displayed on the display screen 32 in accordance with a tilt of the information processor 30 in the same manner as the first modification, even when three operating panels are included in the virtual entire image, thereby achieving the same effect as the first modification.

### Second Embodiment

A second embodiment is an example in which, in accordance with the end of the display of the operating panel displayed on a display screen of an information processor, a window corresponding to an operating panel other than the operating panel whose display is ended is displayed in a full-screen manner. The following description omits a description of the same parts as in the first embodiment.

In the present embodiment, when an operation is input through the input module 38 to end the display of the operating panel displayable on the display screen 32, the operating panel controller 371 of the information processor 30 causes the display screen 32 to display any one operating panel other than the operating panel whose display is ended and transmits an instruction to the display device 20 to change a window display manner so that the display screen 292 of the display device 20 displays the window corresponding to the displayed operating panel in a full-screen manner (hereinafter called the second change instruction).

In the present embodiment, upon receipt of the second change instruction from the information processor 30, the window controller 251 of the display device 20 causes the display screen 292 to display the window corresponding to the operating panel other than the image to be displayed whose display is ended in a full-screen manner.

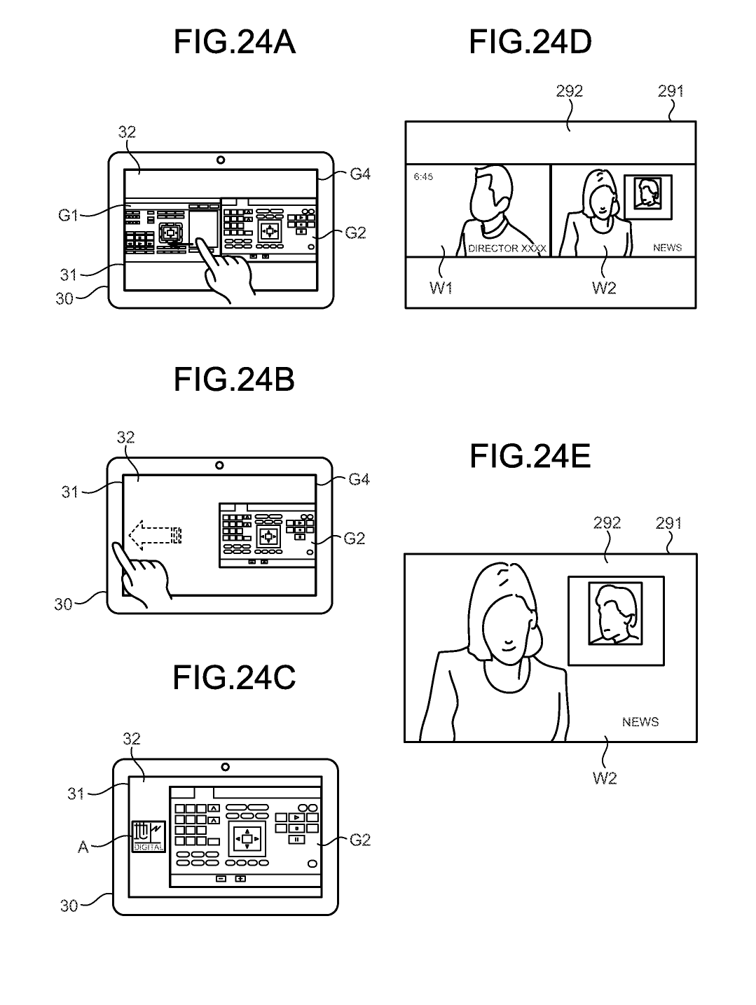

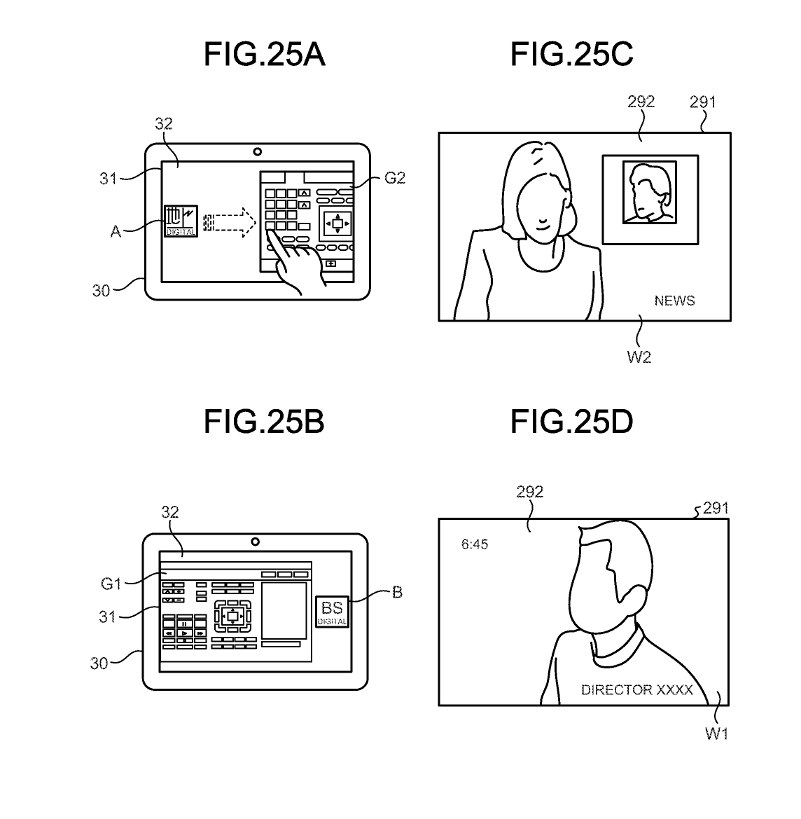

FIGS. 24A to 24E and FIGS. 25A to 25D are diagrams for illustrating processing that displays a window corresponding to an operating panel other than an image to be displayed whose display is ended in a full-screen manner in a display device according to the second embodiment. For example, as illustrated in FIG. 24A and FIG. 24B, when the information processor 30 is in the layout change mode and an operation is input through the input module 38 to flick the operating panel G1 among the operating panels G1 and G2 included in the image G4 for layout change use toward the outside of the display screen 32 (see FIG. 24A), the operating panel controller 371 of the information processor 30 ends the display of the operating panel G1 and causes the display screen 32 to display the image G4 for layout change use including the operating panel G2 other than the operating panel G1 whose display is ended (see FIG. 24B).

The operating panel controller 371 then transmits to the display device 20 the second change instruction that instructs to change the window display manner so that the display screen 292 of the display device 20 displays the window W2 corresponding to the operating panel G2 in a full-screen manner. As illustrated in FIG. 24C, along with the end of the display of the operating panel G1, the operating panel controller 371 causes the display screen 32 to display an icon A indicating the window W1 corresponding to the operating panel G1 whose display is ended and the operating panel G2.

In a situation in which the window W1 and the window W2 are displayed on the display screen 292 (see FIG. 24D), when the second change instruction is input through the information processor 30, the window controller 251 of the display device 20 causes the display screen 32 to display the window W2 corresponding to the operating panel G2 other than the operating panel G1 whose display is ended (see FIG. 24E).

Thereafter, when an operation is input through the input module 38 to flick the operating panel G2 displayed on the display screen 32 toward the outside of the display screen 32 (see FIG. 25A), the operating panel controller 371 of the information processor 30 ends the display of the operating panel G2 and causes the display screen 32 to display the operating panel G1 corresponding to the window W1 indicated by the icon A and an icon B indicating the window W2 corresponding to the operating panel G2 whose display is ended (see FIG. 25B). The operating panel controller 371 then transmits to the display device 20 the second change instruction so that the display screen 292 of the display device 20 displays the window W1 corresponding to the displayed operating panel G1 in a full-screen manner.

In a situation in which the display screen 32 displays the window W2 in a full-screen manner (see FIG. 25C), when the second change instruction is input through the information processor 30, the window controller 251 of the display device 20 causes the display screen 292 to display the window W1 corresponding to the operating panel G1 other than the operating panel G2 whose display is ended in a full-screen manner (FIG. 25D).

As described above, the second embodiment allows, in accordance with the end of the display of the operating panel displayed on the display screen 32 of the information processor 30, display of the window corresponding to the operating panel other than the operating panel whose display is ended, thereby changing the window display manner displayed on the display screen 292 of the display device 20 in accordance with the end of the display of the operating panel on the information processor 30.

A computer program to be executed on the display device 20 and the information processor 30 of the present embodiment may be configured to be recorded in a computer-readable recording medium such as a CD-ROM, a flexible disk (FD), a CD-R, and a digital versatile disk (DVD) as a file in an installable format or an executable format to be provided.

The computer program to be executed on the display device 20 and the information processor 30 of the present embodiment may be configured so that it is stored in a computer that is connected to a network such as the Internet and is downloaded through the network to be provided. The computer program to be executed on the display device 20 and the information processor 30 of the present embodiment may be provided or distributed through a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a display comprising a display screen;
an operating module configured to be capable of receiving an operation with respect to an image displayed on the display screen; and
a controller configured to receive, from an external display device, layout information on layout of a plurality of display images displayed on an external display screen of the external display device, and to bring, based on the received layout information, a layout of a plurality of operation images displayable on the display screen and corresponding to the respective display images close to the layout of the display images corresponding to the operation images.

2. The information processor of claim 1, wherein, when the layout of the operation images is changed, the controller is configured to transmit to the external display device a change instruction that instructs to change the layout of the display images so that the display images are arranged in a layout close to the changed layout of the operation images.

3. The information processor of claim 1, wherein the controller is configured to cause the display screen to display a display target image that is at least one of the operation images within a virtual entire image, the virtual entire image being larger than a display size of the display screen and including the operation images.

4. The information processor of claim 3, wherein the controller is configured to cause the display screen to display position information on a position of at least other one of the operation images other than the display target image and the display target image.

5. The information processor of claim 4, further comprising a first detector configured to detect a tilt of the information processor, wherein
the virtual entire image is arranged on a virtual plane including the display screen, and,
when the first detector detects the tilt of the information processor, the controller is configured to slide at least one of the operation images that is above the display target image into the display screen to change the operation images, the operation images being included in the virtual entire image.

6. The information processor of claim 1, further comprising a second detector configured to detect angular acceleration when the information processor rotates about an axis of rotation perpendicular to the display screen, wherein,
when, following the detection of angular acceleration resulting from the rotation of the information processor in a first direction, the second detector detects angular acceleration larger than predetermined angular acceleration and resulting from the rotation of the information processor in a second direction opposite the first direction, the controller is configured to rotate the layout direction of the operation images in the first direction.

7. The information processor of claim 1, wherein, when an operation that ends display of the operation image is received, the controller is configured to cause the display screen to display one of the operation images other than one of the operation images whose display is ended, and to transmit to the external display device a second change instruction that instructs to change a display manner of the display image so that the external display screen displays the display image corresponding to the displayed operation image in a full-screen manner.

8. The information processor of claim 7, wherein the controller is configured to cause the display screen to display an icon indicating the display image corresponding to the operation image whose display is ended.

9. A display control method performed by an information processor comprising a display and an operating module, the display comprising a display screen, the operating module being configured to be capable of receiving an operation with respect to an image displayed on the display screen, the display control method comprising:
receiving, by a controller from an external display device, layout information on layout of a plurality of display images displayed on an external display screen of the external device, and bringing, by the controller based on the received layout information, a layout of a plurality of operation images displayable on the display screen and corresponding to the respective display images close to the layout of the display images corresponding to the operation images.
